(19) United States
(12) Patent Application Publication
(10) Pub. No.: US 2006/0198970 A1
(43) Pub. Date: Sep. 7, 2006

(54) Support for electrophotographic recording medium, method for manufacturing the same and electrophotographic recording medium using the same

(76) Inventor: Shigehisa Tamagawa, Shizuoka (JP)

Correspondence Address: YOUNG & THOMPSON, 745 SOUTH 23RD STREET, 2ND FLOOR, ARLINGTON, VA, 22202, US

(21) Appl. No.: 11/366,490

(22) Filed: Mar. 3, 2006

(30) Foreign Application Priority Data
Mar. 4, 2005 (JP) 2005-061566

(51) Int. Cl. B32B 23/04

(52) U.S. Cl. 428/32.22; 428/532

(57) ABSTRACT

A support for an image recording medium includes base paper containing a metallic compound and at least one polymer coating layer formed on both side surface of the base paper, at least one of the polymer coating layers containing a blending polymeric antistatic agent which is composed of a polymeric antistatic agent of a one of a polyether type, a betaine type or an ionomer type.

### BACKGROUND OF THE INVENTION

1. Field of the Invention

The present invention relates to a support for an image recording medium that has distinguished adhesion property between the support and an image recording layer and distinguished antistatic property, is excellent in transport quality during manufacturing and its use, and is capable of forming high quality images without an occurrence of blisters, image recording irregularities and/or image fixing irregularities and is kept free from an occurrence of color fade-out, a method of manufacturing the support for an image recording medium, and an image recording medium using the support.

2. Description of Related Art

It is typical to use base paper, synthetic paper, synthetic resin paper, coated paper, laminated paper, etc. for supports for various image recording mediums such as electrophotographic paper, thermal recording paper, inkjet recording paper, sublimation transfer recording paper, thermal development recording paper, silver halide photographic paper, thermal transfer recording paper and so forth. Among them, coated paper and laminated paper are widely and favorably used for such a support. From the viewpoint of preventing an occurrence of image recording irregularities and/or image fixing irregularities, it has been proposed to form a layer comprising at least one polymer coating layer on both surfaces of the support.

However, when using the support for the electrophotographic paper, the thermal recording paper, the inkjet recording paper or the like, the paper is charged with static electricity due to friction by carrying rollers during manufacturing the support or the electrophotographic paper, or during recording images on the image recording paper. In consequence, dusts are apt to stick to the electrophotographic papers, leading to deterioration in transport quality which is one of causes for errors such as a paper jam.

One of approaches for preventing static build-up of the paper, which is described in, for example, Unexamined Japanese Patent Publication Nos. 3-206440, 6-332107, 8-211645, 10-6640, 11-119460 and 2004-191678, is to apply an inorganic salt, a metallic compound or an antistatic agent of low molecular weight to a surface of the resin coating payer or a base material. Another approach described in, for example, Unexamined Japanese Patent Publication No. 6-337498, is add a surface-active agent as an antistatic agent in the resin layer.

However, in the case of the silver halide photographic paper for which a photographic developer is used, the low molecular weight antistatic agent solves out into the photographic developer and, inconsequence, possibly contaminates it. Further, antistatic agents cause image recording mediums such as electrophotographic paper, thermal recording paper and various thermal transfer paper to deteriorate their adhesion, leading to a problem that the image recording layer sticks to a carrying roller or the like in a high temperature heating process for image recording. Additionally, antistatic agents cause deterioration in adhesion between the support and the image recording layer even though they bring about an effect of preventing heat-affected electrostatic build-up and, in consequence, cause quality failures of the image recording mediums such as an occurrence of a set-off image.

Therefore, in the present circumstances, there has remained a strong demand for a support for an image recording medium that has a distinguished adhesion property between the support and an image recording layer and a distinguished antistatic property, excels in transport quality during manufacturing and using the image recording medium, and is capable of forming high quality images without an occurrence of blisters, image recording irregularities and/or image fixing irregularities and free from color fade-out, a method of manufacturing the support for an image recording medium, and an image recording medium using the support.

### SUMMARY OF THE INVENTION

It is therefore an object of the present invention to provide a support for an image recording medium that has a distinguished adhesion property between the support and an image recording layer formed on the support and a distinguished antistatic property, is excellent in transport quality during manufacturing and using the image recording medium, and is capable of forming high quality images without occurrences of blisters, image recording irregularities, image fixing irregularities and color fade-out.

It is another object of the present invention to provide a method of manufacturing the support for an image recording medium.

It is a further object of the present invention to provide an image recording medium using the support.

According to an aspect of the present invention, a support for an image recording medium comprises base paper containing a metallic compound, one or more obverse side polymer coating layers formed on an obverse side surface of the base paper on which an image recording layer is formed, and one or more reverse side polymer coating layers formed on a reverse side surface of the base paper, wherein at least one of the obverse side polymer coating layers and the reverse side polymer coating layers contains a blending polymeric antistatic agent therein.

The blending polymeric antistatic agent comprises one selected from a group of polyether type antistatic agents, a betaine type polymer antistatic agent and an ionomer type antistatic agent and is contained in the polymer coating layer in a range of from 1 to 30% by mass.

The metallic compound comprises at least one of alkali metal salts and alkali earth metal salts and is contained in the base paper more than 0.3 g/m².

The support may comprises at least two reverse side polymer coating layers formed on a reverse side surface of the base paper at least one of which contains a blending polymeric antistatic agent. The polymer coating layer may contain a polyolefin resin, and the outermost polymer coating layer may contain a polyolefin resin.

The support is suitably used for an image recording medium on which an image is thermally recorded, thermally development or thermally fixed.

According to another aspect of the present invention, a method for manufacturing the support of the present invention comprises the steps of preparing the base paper and forming at least one layer of a molten composition of a polymer with a polymeric antistatic agent blended therein on an obverse side surface of the base paper by melt lamination. The support manufacturing method is suitable for an image recording medium using the support on which an image is thermally recorded, thermally development or thermally fixed.

According to still another aspect of the present invention, an image recording medium comprises the support and an image recording layer formed on the obverse side surface of the support. The image recording medium is used suitably in an image recording process in which an image is thermally recorded, thermally development or thermally fixed and is favorably used for electrofotographic paper, thermal recording paper, sublimation transfer paper, thermal transfer paper, thermal development paper, silver halide photographic paper, or inkjet recording paper.

According to a further aspect of the present invention, an image forming method comprises the steps of forming a toner image on an electrophotographic medium having a toner receptor layer and smoothing a surface of the toner image formed on the toner receptor layer.

For the toner image surface smoothing step, it is preferred to use a device having heating means, belt transfer means and cooling means for heating, pressing, peeling the toner image. The belt means comprises a belt comprising a belt support and a surface layer formed on the belt support that contains fluorocarbon siloxane rubber. The surface layer may comprises an under layer containing silicone rubber and an upper layer containing fluorocarbon siloxane rubber which is preferably at least one of a perfluoroalkyl ether group and a perfluoroalkyl group in a principal chain.

The support for an image recording medium of the present invention as described above has a distinguished adhesion property between the support and an image recording layer, a distinguished antistatic property and enhanced transport quality during manufacturing and using the image recording medium, and is capable of forming high quality images without an occurrence of blisters, image recording irregularities, image fixing irregularities and color fade-out. In addition, the image recording medium using the support prevents the antistatic agent from solving out into a photographic developer, and hence from bringing prolusion to it. Consequentially, it is made possible to use the photographic developer economically and to keep the antistatic agent from sticking carrier rollers or the like. This is contributive to improvement of transport quality and durability of image recording equipments.

The image recording medium using the support of the present invention has transport quality during manufacturing and image recording besides distinguished adhesion property between the support and the image recording layer and distinguished antistatic property, and is capable of forming high quality images without occurrences of blisters, image recording and/or fixing irregularities and color fade-out Accordingly, the image recording medium is used favorably for electrofotographic paper, thermal recording paper, sublimation transfer paper, thermal transfer paper, thermal development paper, silver halide photographic paper, or inkjet recording paper.

The image recording method for recording images on the image recording medium of the present invention includes the step of forming a toner image on an electrophotographic recording medium having a toner receptor layer on the support and smoothing a surface of the toner image formed on the toner receptor layer. The image recording method thus comprised makes the electrophotographic recording medium possible to provide quality images without blisters, image recording irregularities, image fixing irregularities and color fade-out.

### BRIEF DESCRIPTION OF THE DRAWINGS

The foregoing and other objects and features of the present invention will be clearly understood from the following detailed description when read with reference to the accompanying drawing, in which:

FIG. 1 is a schematic view of an image surface smoothing and fixing device;

FIG. 2 is a schematic view of an image forming equipment by way of example; and

FIG. 3 is a schematic view of an image surface smoothing and fixing device incorporated in the image forming equipment of FIG. 2.

### DETAILED DESCRIPTION OF THE PREFERRED EMBODIMENTS

A support for an image recording medium of the present invention comprises base paper containing a metallic compound, one or more obverse side polymer coating layers formed on an obverse side surface of the base paper on which an image recording layer is formed, and one or more reverse side polymer coating layers formed on a reverse side surface of the base paper, wherein at least one of the obverse side polymer coating layers and the reverse side polymer coating layers contains a blending polymeric antistatic agent therein. In this instance, the support is favorably used for an image recording process including at least one of thermal recording, thermal development and thermal fixation.

Further, the method for manufacturing the image recording medium comprises forming at least one layer of a molten composition of a polymer with a polymeric antistatic agent blended therein on an obverse side surface of the base paper by melt lamination coating and other steps as appropriate.

The base paper is not especially bounded by types. Specifically, preferred examples of the base paper include, but not limited to, bond paper and paper described in “Fundamentals of Photographic Engineering—Silver halide Photography—” pages from 223 to 240, edited by Japanese Society of Photograph (published 1979 by Corona Co., Ltd.).

The base paper may contain a metallic compound of 0.3 g/m² or more or may have an antistatic property of its own. If the base paper contains a metallic compound less than 0.3 g/m², it possibly becomes poor in antistatic performance. It is desirable to set a ceiling on the metallic compound content which is preferably 3 g/m². If the base paper contains a metallic compound greater than 3 g/m², the base paper possibly encounters aggravation of stability of a coating liquid applied thereto. The metallic compound is not especially bounded by type as long as it is capable of creating an antistatic property for the base paper. Preferred examples of the metallic compound include, but not limited to, either alkali metal salts or alkali earth metal salts, and more specifically sodium chloride, calcium chloride, sodium sulfate, potassium sulfate, potassium chloride, magnesium chloride or the like. Among them, it is preferred to use sodium chloride or calcium chloride.

In order to create desired average surface roughness on the base paper, it is preferred to use pulp fibers having a fiber length distribution such as disclosed in, for example, Japanese Unexamined Patent Publication No. 58-68037, in which the pulp fibers contain a total part of residual pulp fibers screened with a 24-mesh screen and residual pulp fibers screened with a 42 mesh screen in a range of from 20 to 45% by mass and a part of residual pulp fibers screened with 24 mesh screen of less than 5% by mass. The average surface roughness can be adjusted by applying a surface treatment with heat and pressure to the base paper using a machine calender or a super calender.

The base paper is not bounded by raw material. Various known raw materials that are used for supports. Examples of the raw material include, but not limited to, natural pulp such as softwood or coniferous tree pulp and hardwood or broad leaf tree pulp, synthetic pulp made of a plastic material such as polyethylene or polypropylene, and a mixture of natural pulp and synthetic pulp. Although it is preferred to use bleached broad leaf tree kraft pulp (LBKP) for the base paper in terms of improving surface smoothness, rigidity and dimensional stability (curling property) all together to a sufficient and balanced level, it is allowed to use bleached coniferous tree kraft pulp (NBKP) or broad leaf sulphite pulp (LBSP). A beater or a refiner may be used to beat the pulp. It is preferred for the pulp to have a freeness in a range of from 250 to 380 ml in Canadian Standard Freeness (C.S.F.) from the viewpoint of controllability of paper shrinkage in a paper making process.

Pulp slurry prepared by beating the pulp (which is hereinafter referred to as a pulp stock in some cases) may be added with various additives, e.g. a filler, a dry strength stiffening agent, a sizing agent, a wet strength stiffening agent, a fixing agent, a pH adjuster, a pitch controller, a slime controller and other chemical conditioners, as appropriate.

Examples of the filler include, for example, calcium carbonate, clay, kaolin, a white earth, talc, a titanium oxide, a diatom earth, barium sulfate, an aluminum hydroxide, a magnesium hydroxide, calcined clay, deramiekaoline, calcium carbonate heavy, precipitated calcium carbonate, magnesium carbonate, barium carbonate, a zinc oxide, a silicone dioxide, amorphous silica, a calcium hydroxide, a zinc hydroxide, a urea-formalin resin, a polystyrene resin, a phenol resin, fine hollow particles, etc.

Examples of the dry strength stiffening agent include, for example, cationic starch, cationized polyacrylamide, anionized polyacrylamide, amphoteric polyacrylamide, carboxy-modified polyvinyl alcohol, etc.

Examples of the sizing agent include, for example, salts of higher fatty acid such as a styrene-acrylic type compounds, a petroleum resin type sizing agents, rosin, rosin derivatives such as maleic rosin, paraffin wax, a compound containing a higher fatty acid such as a nalkylketene dimmer, an alkenyl anhydrate succinic acid (ASA), an epoxidized fatty acid salt or the like.

Examples of the wet strength stiffening agent include, for example, polyamine polyamide epichlorohydrin, a melamine resin, a urea resin, an epoxidized polyamide resin, etc.

Examples of the fixing agent include, for example, polyvalent metallic salts such as aluminum sulfate and aluminum chloride; basic aluminum compounds such as sodium aluminate, basic aluminum chloride, basic polyaluminum hydroxide; polyvalent metallic compounds such as ferrous sulfate and ferric sulfate; water-soluble polymers such as starch, processed starch, polyacrylamide, urea resins, melamine resins, epoxy resins, polyamide resins, polyamine resins, polyethylene imine, plant gum, polyethylene oxides, etc.; cationic polymers such as cationized starch; dispersion matters, derivatives and compounds of hydrophilic bridged polymer particles, etc.

Examples of the pH adjuster include, for example, caustic soda, sodium carbonate, etc.

Examples of the other chemical conditioners include, for example, a defoaming agent, dye, a slime controlling agent, a fluorescent brightening agent, etc. In addition, it is allowed to add a softening agent as appropriate. Examples of the softening agent include, for example, those enumerated in “New Handbook For Paper Processing” (1980, Paper Chemicals Times), pages 554 and 555.

These additives may be added individually or in any combination of two or more. The additive content of the pulp stock is preferably in, but not limited to, a range of from 0.1 to 1.0% by mass.

The base paper is made from the pulp stock with additives added as appropriate by the use of a paper machine such as a hand paper machine, a foundrinier paper machine, a circular paper machine, a twin-wire paper machine or a combination paper machine, and then dried. It is appropriate to apply a sizing treatment to the dried base paper before or after drying the base paper. A processing liquid that is used for the sizing treatment is bounded by type and may contain a water-soluble polymer, a water-resisting agent, pigment, dye, a luorescent brightening agent, etc.

Examples of the water-soluble polymer include, for example, cationized starch, oxidized starch, polyvinyl alcohol, carboxy-modified polyvinyl alcohol, acrboxymethyl cellulose, hydroxyethyl cellulose, cellulose sulfate, gelatin, casein, sodium polyacrylate, a sodium salt of styrene-maleic anhydrate copolymer, polystyrene sulphonate sodium, etc.

Examples of the water-resisting agent include, for example, latex emulsions such as a styrene-butadiene copolymer, an ethylene-vinyl acetate copolymer, polyethylene, vinylidene chloride copolymer, etc.; polyamide polyamine epichlorohydrin; synthetic wax; etc.

Examples of the pigment include, for example, calcium carbonate, clay, kaolin, talc, barium sulfate, a titanium oxide, etc.

It is preferred for the base paper to have a ratio of longitudinal Young's modulus (Ea) to transverse Young's modules in a range of from 1.5 to 2.0 in terms of improvement of rigidity and dimensional stability (curling property). If the Ea/Eb ratio exceeds the lower limit of 1.5 or the upper limit of 2.0, the electrphographic image recording medium possibly encounters aggravation of rigidity and curling property which leads to undesirable aggravation of transport quality.

Generally, it has been known that what is called “firmness” of paper varies depending upon beating manners. Elastic force (an elastic modulus) of paper manufactured from beaten pulp can be utilized as a key factor for defining the degree of “firmness” of the paper. In particular, since a dynamic elastic modulus that shows a solid state property of paper as a visco-elastic body is closely related to density of the paper, the elastic modulus of the paper is expressed in terms of an acoustic propagation velocity the through paper that is measured by an ultrasonic transducer as below.
E=ρc²(1−n²)
where E is the dynamic elastic coefficient;

ρ is the paper density;

c is the acoustic propagation velocity through paper

n is Poisson's ratio.

Because Poisson's ratio (n) of ordinary paper is approximately 0.2, the dynamic elastic modulus can be approximated as follows.
E=ρc²
That is, the elastic modulus is easily obtained by measuring paper density and an acoustic propagation velocity. An acoustic propagation velocity of paper can be measured by an instrument well known in the art such as, for example, Sonic Tester Model SST-110 (Nomura Co., Ltd.).

The base paper is not bounded by thickness. It is ordinarily appropriate for the base paper to have a thickness in a range of from 30 to 500 μm, more preferably in a range of from 50 to 300 μm, and most preferably in a range of from 100 to 250 μm. It is also appropriate for the base paper to have a basic weight preferably in, but not limited to, a range of from 50 to 250 g/m² and more preferably a range of from 100 to 200 g/m².

It is preferred to apply a calendering treatment to the base paper. The calendering treatment is desirably implemented so that the base paper at an obverse side surface where an image forming layer is formed is contacted by a metal roller heated at a surface temperature preferably higher than 100° C., more preferably higher than 150° C., most preferably higher than 200° C. It is not always required for the calendering treatment to set a ceiling on the roller surface temperature, and the roller surface temperature is preferably less than approximately 300° C. Further, the calendering treatment is not bounded by nip pressure, and the nip pressure is preferably higher than 100 kN/cm², and more preferably between 100 and 600 kN/cm².

The calendering treatment is not bounded by roller type. Examples of applicable calender roller include, for example, a soft calender roller comprising a combination of a metal roller and a synthetic resin roller, a machine calender roller comprising a pair of metal rollers, etc. Among them, it is preferred to employ the soft calender roller and especially preferred to employ a long nip shoe calender roller comprising a metal roller and a shoe roller with a plastic belt incorporated in the viewpoint that a large nip width can be provided so as thereby to increase an contact area between a cast coat layer of the base paper and the metal roller.

The base paper is provided with at least one polymer coating layer formed on both side surfaces. More specifically, it is preferred to form one or more obverse side polymer coating layers formed on an obverse side surface of the base paper on which an image recording layer is formed and one or more reverse side polymer coating layers formed on a reverse side surface of the base paper. At least one of the polymer coating layers contains a blending polymeric (high molecular) antistatic agent. The support made of the base paper having at least one polymer coating layer with a polymeric antistatic agent blended therein ensures that the support for an image recording medium has a distinguished adhesion property between the support and an image recording layer, excellent transport quality when manufacturing the support, recording images on an image recording medium using the support, processing and fixing the image recording medium and that the an image recording medium is capable of forming high quality images without an occurrence of blisters, image recording irregularities and/or image fixing irregularities. Furthermore, the image recording medium using the support prevents the antistatic agent solving out into a photographic developer, sticking of the image recording medium to an image recording device and/or causing a set-off image. This leads to enhancement of economical efficiency.

Examples of the blending polymeric antistatic agent include, but not limited to, a polyether type polymeric antistatic agents such as polyether ester amide, polyether amideimide, ethylene oxide-epihalohydrin, etc.; a betaine type polymeric antistatic agents such as carbobetaine graft copolymers, etc.; and an ionomer type polymer antistatic agents such as potassium ionomers, rubidium ionomers, cesium ionomers, etc. Among them, polyether type polymer antistatic agents are especially preferred.

It is preferred for the polymer coating layer to contain a blending polymeric antistatic agent in a range of from 1 to 30% by mass, and more preferably in a range of from 3 to 15% by mass. The support possibly becomes too poor in antistatic effect if the content of blending polymeric antistatic agent is less than 1% by mass, and possibly causes film cracks in the polymer coating later if the content of blending polymeric antistatic agent exceeds 30% by mass.

It is preferred to form two or more reverse side polymer coating layers on the reverse side surface of the base paper at least one of which contains the blending polymeric antistatic agent. In this instance, it is preferred that the outermost polymer coating layer contains the blending polymeric antistatic agent. The support made of the base paper having the outermost polymer coating layer containing the polymeric antistatic agent blended therein prevents an image recording medium using the support from being charged with static electricity due to friction by carrying rollers. This leads to improvement of a transport quality of the image recording medium. It is preferred for the polymer coating layer containing the blending polymeric antistatic agent to have a thickness greater than 2 μM, and more preferably in a range of from 5 to 30 μm. If the thickness is less than 2 μm, a critical temperature for an occurrence of blisters drops away, so that the polymer coating layer causes blisters at lower temperatures. On the other hand, if the thickness exceeds 30 μm, the productivity of the support possibly falls down due to constrains on a discharge rate of a molten resin. Further, it is preferred for the polymer coating layer containing no antistatic agent to have a thickness greater than 2 μm, and more preferably in a range of from 5 to 50 μm. If the thickness is less than 2 μm, an image recording medium possibly causes image recording irregularities and/or image fixing irregularities due to failure tracking ability. If the thickness exceeds 50 μn, the productivity of the support possibly falls down due to constrains on a discharge rate of a molten resin.

The polymer coating layer is not bounded by material and preferred to be of a polyolefin. It is common to form the polyolefin resin layer from low density polyethylene resins. However, in terms of improvement of heat resistance of the support, it is however preferred to form the polyolefin resin layer from a polypropylene resin, a blend of polypropylene resin and polyethylene resin, a high density polyethylene resin, or a blend of high density polyethylene resin and low density polyethylene resin. Especially, in terms of production cost and lamination adaptability, it is most preferred to employ a blend of high density polyethylene resin and low density polyethylene resin. The blending ratio (high density polyethylene resins:low density polyethylene resin) is preferred to be in a range of from 1:9 to 9:1 by mass, more preferably in a range of from 2:8 to 8:2 by mass, and most preferably in a range of from 3:7 to 7:3 by mass.

It is preferred that at least either polyolefin resin layer contains organic or inorganic pigment. The organic pigment is not bounded by type. Known examples of the organic pigment include, but not limited to, ultramarine blue, cerian blue, copper phthalocyanine blue, cobalt violet, fast violet, manganese violet, etc. Known examples of the inorganic pigment include, but not limited to, titanium dioxides, calcium carbonate, talc, amide stearate, zinc stearate, etc. Among them, it is most preferred to use a titanium dioxide which may be of an anatase type or of a rutile type. It is preferred that the polyolefin resin layer contains the titanium dioxide in a range of from 5 to 30% by mass.

Various coating processes of the polyolefin resin layer are known, and any coating process well known in the art may be employed as long as it forms a lamination of a molten polymer composition with a polymeric antistatic agent blended therein on the base paper. Examples of the coating process include, but not limited to, an ordinary laminating process; a sequential laminating process; a laminating process using a single layer extrusion die or a multi layer of a feed block type, a multi manifold type, a multi slot type or the like, or a laminator; a coextrusion coating process of forming multiple layers simultaneously. The single layer extrusion die and the multilayer extrusion die are not bounded by shape and, however, preferred to be of a T-type or of a coat hanger type.

The support for an image recording medium prepared as described above has a distinguished adhesion property between the support and an image recording layer and a distinguished antistatic property, excels in transport quality during manufacturing and using the image recording medium, is capable of forming high quality images without an occurrence of blisters, image recording irregularities and/or image fixing irregularities and free from color fadeout, and is suitably used for an electrophotographic material, a heat sensitive printing material, an inkjet printing material, a sublimation transfer material, a thermal transfer material, a thermal development material, a silver halide photographic material and the like.

The image recording medium of the present invention comprises the support just described above, an image recording layer and, if desired, one or more other layers. The image recording medium is preferred to be subject to at least one of thermal recording, thermal development and thermal fixation. It is preferred to use a thermal head or a laser for the thermal recording, a heating roller, a heating belt, a plate heater, a thermal head, a laser or a combination of one or more of them for the heat development, and a fixing roller, a fixing belt or a combination of them for the heat fixation.

The image recording medium is different in structure according to its applications, namely electrophotography, thermal printing, inkjet printing, sublimation transfer, thermal transfer, thermal development and silver halide photography. The following description will be given in detail according to application.

The image recording medium used for electrophotography, taking the form of paper, comprises a paper support made of the support of the present invention, a toner receptor layer formed at least one side of the paper support, and various other layers selected as appropriate. Examples of the other layers include a surface protective layer, a backing layer, an interlayer adhesion improvement layer, an intermediate layer, an under layer, a cushioning layer, an electrostatic charge control or antistatic layer, a reflection layer, a tint adjusting layer, a storage stability improvement layer, an anti-adhesion layer, an anti-curling layer and a smoothing layer. These layers may take a single layered structure or a multi layered structure.

The toner receptor layer receives color toners and a black toner to form a color image thereon. More specifically, the toner receptor layer receives toners from a development drum or an intermediate transfer medium by means of (static) electricity or pressure to form a toner image during an image transfer process and solidifies the toner image with heat or pressure in a toner image fixing process. It is suitable for the toner receptor layer to have a lower transparency such as preferably less than 70% in optical transmittance, more preferably less than 75% and most preferably less than 75% in terms of providing feelings like a photographic print. The optical transmittance can be found by, for example, measuring an optical transmittance of a sample toner coating film of the same thickness as the toner receptor layer formed on a polyethylene terephthalate film of 100 μm in thickness on a direct reading Hayes meter (for example Model HGM-2DP: Suga Testing Machine Co., Ltd.).

The toner receptor layer contains at least a thermoplastic resin and, if necessary, various additives for the purpose of improving thermodynamic properties thereof such as a releasing agent, a plasticizing agent, a coloring agent, a filler, a cross-linking agent, an electrostatic charge control agent, an emulsifying agent, a dispersing agent, etc.

Examples of the thermoplastic resin for the toner receptor layer include, but not limited to, (1) a polyolefin type resins, (2) a polystyrene type resins, (3) an acryl type resins, (4) polyvinyl acetate or derivatives polyvinyl acetate, (5) a polyamide type resins, (6) polyester resins, (7) polycarbonate resins, (8) polyether resins or acetal resins, and (9) other resins. These thermoplastic resins may be selectively used individually or in any combination of two or more of them. In terms of toner burying, it is especially preferred to employ a styrene type resins, an acryl type resins, or a polyester type resins which are high in cohesive energy.

Examples of (1) the polyolefin type resins include, but not limited to, polyolefin resins such as polyethylene and polypropylene; copolymer resins of olefin such as ethylene or propylene polymerized with another vinyl monomer; etc. Examples of the copolymer resin of the olefin and another vinyl monomer include ethylene-vinyl acetate copolymers; and ionomer resins that are copolymers polymerized with an acrylic acid or a methacrylic acid. In this instance, examples of the derivative of a polyolefin resin include chlorinated polyethylene and chlorosulfonated polyethylene.

Examples of (2) the polystyrene type resins include, but not limited to, polystyrene resins, styrene-isobutylene copolymers, styrene-isobutylene copolymers, aclylonitrile-styrene copolymers (AS resins), acrylonitrile-butadiene-styrene copolymers (ABS resins), polystyrene-maleic anhydride resins, etc.

Examples of (3) the acryl type resins include, but not limited to, a polyacrylic acid or their ester, polymethacrylic acids or their ester, polyacrylonitrile, polyacrylamide, etc. Examples of the ester of polyacrylic acid include homopolymers or multiple copolymers of ester of acrylic acid, etc. Example of the ester of acrylic acid include methyl acrylate, ethyl acrylate, n-butyl acrylate, isobutyl acrylate, doecyl acrylate, n-octyl acrylate, 2-ethylhexyl acrylate, 2-chrolethyl acrylate, phenyl acrylate, α-chlor methyl acrylate, etc. Examples of the ester of polymethacrylic acid include homopolymers or multiple copolymers of ester of methacrylic acid, etc. Examples of the ester of a methacrylic acid include methyl acrylate, ethyl acrylate, butyl acrylate, etc.

Examples of (4) the polyvinyl acetate or its derivative include polyvinyl acetate, polyvinyl alcohol derived by saponifying polyvinyl acetate, polyvinyl acetal resins derived by reacting polyvinyl alcohol with aldehyde (e.g. formaldehyde, acetaldehyde, butylaldehyde, etc.), etc.

Examples of (5) the polyamide type resins, that are polycondensation products of diamine and diacid base, include 6-nylon, 6,6-nylon, etc.

Examples of (6) the polyester resin can be produced by condensation polymerization of an acid component and alcohol. Examples of the acid composition include, but not limited to, a maleic acid, a fumaric acid, a citraconic acid, an itaconic asid, a glutaconic asid, a phthalic acid, a terephthalic acid, an iso-phthalic acid, a succinic acid, an adipic acid, a cebacis acid, an azelaic acids, malonic acids, n-dodecenylsuccinate, iso-dodecenylsuccinate, n-dodecylsuccinate, iso-dodecylsuccinate, n-octenylsuccinate, n-octylsuccinate, iso-octenylsuccinate, iso-octylsuccinate, a triimllitic acid, a pyromellitic acid, anhydride of these acids, lower alkyl ester of these acids, etc. The alcohol component is preferably dihydric. Examples of aliphatic diol include, for example, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, polytetremethylene glycol, etc. Examples of bisphenol A with an adduct of alkylene oxide include, for example, polyoxypropylene (2.2)-2,2-bis(4-hydroxyphenyl)propane, polyoxypropylene (3.3)-2,2-bis(4-hydroxyphenyl)propane, polyoxyethylene (2,0)-2,2-bis(4-hydroxyphenyl)propane, polyoxypropylene(2.0)-polyoxyethylene (2,0)-2,2-bis(4-hydroxyphenyl)propane, polyoxypropylene(6)-2,2-bis(4-hydroxyphenyl)propane, etc.

Examples of (7) the polycarbonate resins include, for example, polycarbonic acid ester derived from bisphenol A and phosgene, etc.

Examples of the polyether resins or acetal resins include, for example, polyether resins such as polyethylene oxides, polypropylene oxides, etc.; acetal resins such as poly-oxymethylene, etc. which are of a ring opening polymerization type.

Examples of (9) the other resins include a polyaddition type polyurethane resins.

In this instance, it is preferred that each thermoplastic resin enables a toner receptor layer to satisfy solid state properties required for the toner receptor layer after formation, and more preferred that the thermoplastic resin itself satisfies the solid state properties of the toner receptor layer. It is also preferred to use two or more thermoplastic resins satisfying different solid state properties required for the toner receptor layer, respectively.

It is preferred for the thermoplastic resin to have a molecular weight greater than a molecular weight of a thermoplastic resin used for a toner. However, this requirement is not always desirable according to relations between thermodynamic characteristics of thermoplastic resins used for the toner receptor layer and the toner. Taking an instance, in the case where the thermoplastic resin for the toner receptor layer has a softening temperature higher than the thermoplastic resin for the toner, it is preferred in some cases that the thermoplastic resin for the toner receptor layer has a molecular weight equal to or less than the thermoplastic resin for the toner.

It is preferred to use a mixture of different thermoplastic resins identical in composition but different in average molecular weight from each other for the toner receptor layer. For a more complete description of the relation with molecular weight of the thermoplastic resin used for toners, see Unexamined Japanese Patent Publication No. 8-334915. It is further preferred for the thermoplastic resin for the toner receptor layer to have a molecular weight distribution wider than that of a thermoplastic resin used for a toner.

It is preferred for the thermoplastic resin to satisfy solid state properties described in, for example, Unexamined Japanese Patent Publication Nos. 5-127413, 8-194394, 8-334915, 8-334916, 9-171265 and 10-221877.

The thermoplastic resin for the toner image receptor layer is preferably of an aqueous type resins such as water-dispersant resins and water-soluble resins for the following reasons (i) and (ii):

(i) The aqueous type resins do not discharge organic solvents in a coating and drying process and, in consequence, excels at environmental adaptability and workability;

(ii) A release agent such as wax are hardly soluble in water at an ambient temperature in many instances and is often dispersed in a solvent such as water or an organic solvent prior to use. The water-dispersant type resin is stable and has a superb adaptability to manufacturing process. In addition, aqueous coating causes wax to easily bleed onto a surface of the toner receptor layer during a coating and drying process, so as thereby to bring out effects of the release agent such as an anti-offset property, anti-adhesion property, etc.).

The aqueous type resin is not always bounded by composition, bond-structure, molecular geometry, molecular weight, molecular weight distribution, etc., inasmuch as it is water-soluble or water-dispersant. Examples of a group for turning the polymer into hydrophilic include, or example, a sulfonic acid group, a hydroxyl group, a carboxylic acid group, an amino group, an amid group, an ether group, etc.

Examples of the water-dispersant polymers include water dispersions, elulsions, copolymers, cation modified maters of the resins categorized into (1) to (9). These water-dispersant polymers may be used individually or in any combination of two or more. The water-dispersant polymer may be synthetized or commercially available product. Examples of commercially available water-dispersant polymer include, for example, Vyronal series polymers (Toyobo Co., Ltd.), Pesuresin A series polymers (Takamatsu Oil & Fats Co., Ltd.), Tafuton UE series polymers (Kao Co., Ltd.), Polyester WR series polymers (Nippon Synthetic Chemical Industry Co., Ltd.), and Elietel series polymers (Unitika Ltd.), all of which are of a polyester type, and Hyros XE series polymers, Hyros E series polymers and Hyros E series polymers (Seiko Chemical Industry Co., Ltd.) and Jurimar T series polymer (Nippon Fine Chemical Co., Ltd.), all of which are of an acrylic type.

The water-dispersant emulsion is not bounded by type. Examples of the water-dispersant emulsions include water-dispersant polyurethane emulsions, water-dispersant polyester emulsions, chloroprene type emulsions, styrene-butadiene type emulsions, nitrile-butadiene type emulsions, butadiene type emulsions, vinyl-chloride type emulsions, vinylpyridine-styrene-butadiene type emulsions, polybutene type emulsions, polyethylene type emulsions, vinyl acetate type emulsions, ethylene-vinyl acetate type emulsions vinylidene chloride type emulsions, methylmethacrylate-butadiene type emulsions, etc. Among them, the water-dispersant polyester emulsions are especially preferred. The water-dispersant polyester emulsion is preferred to be a self-dispersant type of aqueous polyester emulsion, and especially to preferred be a carboxylic self-dispersant aqueous polyester emulsion. In this instance, the self-dispersant aqueous polyester emulsion as used herein shall mean and refer to an aqueous emulsion containing a polyester resin capable of self-dispersing in an aqueous solvent without the aid of an emulsifier or the like, and the carboxylic self-dispersant aqueous polyester resin emulsion as used herein shall mean and refer to an aqueous emulsion containing a polyester resin that contains a carboxyl group as a hydrophilic group and is capable of self-dispersing in an aqueous solvent.

It is preferred for the self-dispersant type water-dispersant polyester emulsion to satisfy the following properties (1) to (4). This is because, since the emulsions that satisfying the specified properties (1) to (4) are of a self-dispersant type containing no surface active agent, they are low in hydroscopic property even in a humid atmosphere, shows a small drop in softening point due to moisture, and is restrained from causing offset during fixation and adhesion defects between electrophotogreaphic paper during storage. In addition, because of an aqueous type, the emulsions excel at environmental adaptability and workability. Furthermore, because the emulsions contain a polyester resin that is apt to take a molecular geometry having high cohesive energy, they take a low elastic or low viscous molten state in a fixing process of an electrophotography while keeping sufficient hardness in a storage environment. This causes toner particles dig into the toner receptor layer, thereby achieving sufficiently high image quality.

(1) Number-average molecular weight (Mn): preferably in a range of from 5,000 to 10,000, and more preferably in a range of from 5,000 to 7,000

(2) Molecular weight distribution (weight-average molecular weight/number-average molecular weight): preferably less than 4, more preferably equal to or less than 3

(3) Glass transition temperature (Tg): preferably in a range of from 40 to 100° C., and more preferably in a range of from 50 to 80° C.

(4) Volume-average grain size: preferably in a range of from 20 to 200 nm, and more preferably in a range of from 40 to 150 nm

It is preferred that the toner receptor layer contains the water-dispersant emulsion in a range of from 10 to 90% by mass, and more preferably in a range of from 10 to 70% by mass.

The water-soluble polymers are not bounded by weight-average molecular weight as long as less than 400,000 and may be synthesized as appropriate or commercially procured. Examples of the water-soluble polymers include, but not limited to, polyvinyl alcohol, carboxy-modified polyvinyl alcohol, carboxymethyl cellulose, hydroxyethyl cellulose, cellulose sulfate, polyethylene oxides, gelatin, cationized starch, casein, sodium polyacrylate, styrene-maleic anhydride copolymers, sodium polystyrene sulfonate. Among them, it is preferred to use polyethylene oxides. Commercially available examples of the water-soluble polymers include, but not limited to, Pluscoat series water-soluble polyester (Gao Chemical Industry Co., Ltd.), Fintex ES series water-soluble polyester (Dainippon Ink & Chemical Inc.); Jurimar AT series water-soluble acryl (Nippon Fine Chemical Co., Ltd.), Fintex 6161 and Fintex K-96 series water-soluble acryl (Dainippon Ink & Chemical Inc.), and Hyros NL-1189 and Hyros BH-997L series water-soluble acryl (Seiko Chemical Industry Co., Ltd.). In addition, those disclosed in Research Disclosure No. 17,643, page 26; No. 18,716, page 651; No. 307,105, pages 873-874; and Japanese Unexamined Patent Publication No. 64-13546, pages 71-75 are available examples of the water-soluble polymers.

It is preferred for the toner receptor layer to contain a water-soluble polymer content in, but not limited to, a range of from 0.5 to 2 g/m².

The thermoplastic resin may be used in combination with another polymeric material and, in this case, should be higher in content than the other. The toner receptor layer contains the thermoplastic resin preferably greater than 10% by mass, more preferably greater than 30% by mass, and especially preferably in a range of from 50 to 90% by mass.

The release agent is blended in the toner receptor layer in order to prevent an occurrence of offsets. The releasing agent is not bounded by type as long as it is capable of melt at a fixing temperature to separated out and unevenly distribute on a surface of the toner receptor layer, and of solidifying by cooling. The release agent may be one of silicone compounds, fluorine compounds, wax and matting agents. Examples of the release agent include wax such as described in “Revised Edition: Property and Application of Wax” (Koushobou); silicone compounds such as described in “Handbook of Silicon” (Nikkan Kogyo Shinbun); and silicone compounds, fluorine compounds and wax suitably used for toner such as described in Japanese Patent Nos. 2,838,498 and 2,949,558; Japanese Patent Publication Nos. 59-38581 and 4-32380; Japanese Unexamined Patent Publication Nos. 50-117433, 52-52640, 57-148755, 61-62056, 61-62057, 61-118760, 242451, 341465, 4-212175, 4-214570, 4-263267, 5-34966, 5-119514, 6-59502, 6-161150, 6-175396, 6-219040, 6-230600, 6-295093, 7-36210, 743940, 7-56387, 7-56390, 7-64335, 7-199681, 7-223362, 7-287413, 8-184992, 8-227180, 8-248671, 8-2487799, 8-248801, 8-278663, 9-152739, 9-160278, 9-185181, 9-319139, 9-319413, 10-20549, 10-48889, 10-198069, 10-207116, 11-2917, 11-449669, 11-65156, 11-73049 and 11-194542. These compounds may be used individually or in combination of two or more.

Examples of the silicone compounds include, for example, silicone oil, silicon rubber, silicon particulates, silicon-modified resins, reactive silicone compounds, etc.

Examples of the silicone oil include, but not limited to, non-modified silicone oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacryl-modified silicone oil, mercapto-modified silicone oil, alcohol-modified silicone oil, alkyl-modified silicone oil and fluorine-modified silicone oil.

Examples of the silicon-modified resins include, but not limited to, olefin resins, polyester resins, vinyl resins, polyamide resins, cellulose resins, phenoxy resins, vinyl chloride-vinyl acetate resins, urethane reins, acryl resins, styrene-acryl resins, and resins made produced by silicon-modifying copolymers of them.

Examples of the fluorine compounds include, but not limited to, fluorine oil, fluoro rubber, fluorine-modified resins, fluorosulfonic acids, fluorosulfonic compounds, fluorine compounds, salts of fluorine acids, inorganic fluorinated substances.

The wax are broadly classified into two categories, namely natural wax and synthetic wax. It is preferred to select the natural wax from a group of vegetable wax, animal wax, mineral wax, and paraffin wax. Among them, vegetable wax is most preferably used. The natural wax is preferred to be of a water-dispersant type in terms of compatibility in the case where an aqueous resin is used for the toner receptor layer.

The vegetable wax is not bounded by type and may be synthesized or of a commercially available product. Examples of the vegetable wax include carnauba wax, castor oil, colza oil, soybean oil, sumac wax, cotton wax, rice wax, sugarcane wax, canderyla wax, Japan wax, jojoba oil, etc. Examples of commercially available carnauba wax include EMUSTAR-0413 wax (Ito Oil Manufacturing Co., Ltd.), Serozole 524 wax (Chukyo Oil & Fats Co., Ltd.) and the like. Examples of commercially available castor oil include refined castor oil (Ito Oil Manufacturing Co.). The carnauba wax having a melt temperature in a range of from 70° C. to 95° C. is especially preferred among them in terms of preeminence in anti-offset property, anti-adhesion property, transport quality, feeling of glossiness, toughness against cracks of the electrophotographic recording medium as well as high image quality.

Examples of the animal wax include, but not limited to, bees wax, lanolin, spermaceti wax, blubber wax (whale oil), wool wax, etc.

The mineral wax is not bounded by type and may be synthesized or of a commertially available product. Examples of the mineral wax include, but not limited to, montan wax, montan type ester wax, ozokerite, ceresin, etc. The montan wax having a melt temperature in a range of from 70° C. to 95° C. is especially preferred among them in terms of preeminence in anti-offset property, anti-adhesion property, transport quality, feeling of glossiness and toughness against cracks of the electrophotographic recording medium as well as high image quality.

The paraffin wax is not bounded by type and may be synthesized or of a commertially available product. Examples of the paraffin wax include, but not limited to, paraffine wax, microcrystalline wax, petrolatum, etc.

The natural wax content of the toner receptor layer is preferably in a range of from 0.1 to 4 g/m², and more preferably in a range of from 0.2 to 2 g/m². If the natural wax content is less than 0.1 g/m², significant deterioration in anti-offset property and anti-adhesion property is possibly caused. On the other hand, if the natural wax content is greater than 4 g/m², the amount of wax is too much to ensure a high image quality. Further, the melt temperature of the natural wax is preferably in a range of from 70 to 95° C., and more preferably in a range of from 75 to 90° C. in terms of, in particular, anti-offset property and transport quality.

The synthetic wax is classified into several types, namely synthetic carbon hydride, modified wax, hydrogenated wax, and other fat and oil type synthetic wax. These wax is preferred to be of a water-dispersant type in terms of compatibility in the case where an aqueous resin is used for the toner receptor layer. Examples of the synthetic carbon hydride include Fischer-Tropsch wax, polyethylene wax, etc. Examples of the fat and oil type synthetic wax include acid amide compounds such as amid stearate, acid imide compounds such as phthalic anhydride imide, etc. Examples of the modified wax include, but not limited to, amine-modified wax, acrylate modified wax, fluorine modified wax, olefin modified wax, urethane type wax and alcohol type wax. Examples of the hydrogenated wax include, but not limited to, cured castor oil, derivatives of castor oil, stearic acids, lauric acids, myristic acids, palmotic acids, behenic acids, sebacic acids, undecylic acids, heptyl acids, maleic acids, high maleic oil, etc.

The melt temperature of the release agent is preferably in a range of from 70 to 95° C., and more preferably in a range of from 75 to 90° C. in terms of, in particular, anti-offset property and transport quality. The release agent used for the toner receptor layer may be derivatives, oxides, or refined products of the substances described above which may have reactive substituents. The release agent content is preferably in a range of from 0.1 to 10% by pass, and more preferably in a range of from 0.3 to 8.0% by mass, and most preferably in a range of from 0.5 to 5.0% by mass relative to the mass of the toner receptor layer. If the release agent content is less than 0.1% by mass, significant deterioration in anti-offset property and anti-adhesion property is possibly caused. On the other hand, if the natural wax content is greater than 10% by mass, the amount of wax is too much to ensure image quality.

The plasticizing agent, that has the function of controlling fluidization or softening of the toner receptor layer with heat and/or pressure in a toner fixing process, is not bounded by type. The plasticizing agent can be selected consulting “Handbook Of Chemistry” (Chemical Society of Japan; Maruzen), “Plasticizer—Theory and Applications—” (Kouichi Murai; Koushobou), “Study On Plasticizer Vol. 1” and “Study On Plasticizer Vol. 2” (Polymer Chemistry Association), or “Handbook Rubber Plastics Compounding Chemicals” (Rubber Digest Ltd.), etc.

Examples of the plasticizing agents include, for example, compounds such as esters (e.g. phthalate ester, phosphate ester, fatty ester, abietate, adipate, sebacate, azelate, benzoate, butyrate, epoxidized fatty ester, glycolate, propionate, trimellitate, citrate, sulfonate, calboxylate, succinate, maleate, phthalate, stearate, etc.); amide (e.g. fatty amide, sulfonamide, etc.); ether; alcohol; lactone; and polyethyleneoxy; which are cited as high boiling point organic solvents and thermal solvents in, for example, Japanese Unexamined Patent Publication Nos. 59-83154, 59-178451, 59-178453, 59-178454, 59-178455, 59-178457, 62-174745, 62-245253, 61-09444, 61-2000538, 62-8145, 62-9348, 62-30247, 62-136646, and 2-235694.

Polymers having comparatively low molecular weights may be used as the plasticizing agent. Such a polymer is preferably lower in molecular weight than a binder resin that is to be plasticized, more specifically, less than 15000 and most preferably less than 5000. In the case of using a polymer for the plasticizing agent, it is preferred for the polymer to be of the same type as a binder resin that is to be plasticized. For example, when plasticizing a polyester resin, it is preferred to use a polyester of low molecular weight. Also, oligomer may be used for the plasticizing agent. In addition to the above mentioned compounds, there are various commercially available plastiizing agents, examples of which include Adecasizer PN-170 and Adecasizer PN-1430 (Asahi Denka Kogyo K.K.); PARAPLEX-G-25, PARAPLEX-G-30 and PARAPLEX-G40 (HALL Corporation); and Estergum 8L-JA, Ester R-95, Pentaryn 4851, Pentaryn FK115, Pentaryn FK4820, Pentaryn FK830, Ruizol 28-JA, Picorastic A75, Picotex LC and Crystalex 3085 (Rika Hercules Co., Ltd.); etc.

The plasticizing agents may be optionally used in order to reduce stress or strain (physical strain of elastic force and/or viscosity, and strain due to mass balance of molecules, main chains and pendants) that occurs in toner particles when the toner particles are buried in the toner receptor layer. The plasticizing agent may be present in the toner receptor layer in a microscopically dispersed state, in a microscopically phase-separated state like a sea-island state, or in a state where the plasticizing agent has mixed with and dissolved in other components such as a binder sufficiently. It is preferred for the toner receptor layer to contain a plasticizing agent in a range of from 0.001% to 90% by mass, more preferably in a range of from 0.1 to 60% by mass, and most preferably in a range of from 1 to 40% by mass. The plasticizing agent may be utilized for the purpose of adjusting a gliding property (improving transport quality due to a reduction in frictional force), improving an offset property at a fixing device (separation of a toner and a toner layer to the fixing device), adjusting a curling balance and controlling static build-up (formation of electrostatic toner image).

Examples of the coloring agent include, but not limited to, fluorescent brightening agents, white pigments, colored pigments, dye, etc. The fluorescent brightening agent is not bounded by type as long as having an absorption feature in a near-ultraviolet range and generating fluorescence in a range of from 400 to 500 nm. Preferred examples of the fluorescent brightening agents include compounds such as disclosed in “The Chemistry of Synthetic Dyes” by K. VeenRatarman, Vol. 8, Chapter 8. Specifically, the compounds may be synthesized or of commercially available products, example of which include stilbene compounds, coumarin compounds, biphenyl compounds, benzooxazoline compounds, naphthalimide compounds, pylazorine compounds, carbostyryl compounds, etc.; and, as commercially available fluorescent brightening agent, White Fulfa PSN, White Fulfa PHR, White Fulfa HCS, White Fulfa PCS and White Fulfa B (Sumitomo Chemical Co., Ltd.), and UVITEX-OB (Chiba-Geigy Ltd.).

Example of the white pigments include, but not limited to, inorganic pigments such as titanium oxides, calcium carbonate, etc.

Examples of the colored pigments include, but not limited to, various pigments described in, for example, Japanese Unexamined Patent Publication No. 63-44653, azo pigments, polycyclic pigments, condensation polycyclic pigments, lake pigments, carbon black, etc. Examples of the azoic pigments include azolake pigment such as carmine 6B and red 2B; insoluble azo pigments such as monoazo yellow, disazo yellow, pyrazolo orange and Balkan orange; condensation azoic pigments such as chromophthal yellow and chromophthal red; etc. Examples of the polycyclic pigments include phthalocyanine pigments such as copper phthalocyanine blue, copper phthalocyanine green, etc. Examples of the condensation polycyclic pigments include dioxazin pigments such as dioxazin violet, isoindorinon pigments such as isoindolynon yellow, slene pigments, perylene pigments, perynon pigments, thioindigo pigments, etc. Examples of the lake pigments include malachite green, rhodamine B, rhodamine G, Victoria blue B, etc. Examples of the inorganic pigments include oxides such as a titanium dioxide, colcothar, etc.; sulfate such as precipitated barium sulfate; carbonate such as precipitated calcium carbonate; silicate such as hydrated silicate, anhydrous silicate, etc.; metal powder such as aluminum powder, bronze powder, blue powder, chrom yellow, iron blue, etc. These pigments may be used individually or in any combination of two or more.

Examples of the dye include, but not limited to, anthraquinone compounds, azoic compounds, etc. These dyes may be used individually or in any combination of two or more.

Examples of water-insoluble dyes include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20 and C.I.Vat blue 35; dispersed dyes such as C.I. disperse violet 1, C.I. disperse violet 4, C.I. disperse violet 10, C.I. disperse blue 3, C.I. disperse blue 7 and C.I. disperse blue 58; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25 and C.I. solvent blue 55; etc. Colored couplers used for silver photography can be preferably utilized.

The coloring agent content of the toner receptor layer is preferably in a range of from 0.1 to 8 g/cm², and more preferably in a range of from 0.5 to 5 g/cm². If the coloring agent content is less than 0.1 g/cm², the toner receptor layer is apt to have a possibly increased optical transmittance. On the other hand, if the coloring agent content is greater than 8 g/cm², the toner receptor layer is apt to become poor in tractability resulting from deterioration in anti-adhesion property and an occurrence of cracks. In particular, the pigment content of the toner receptor layer is preferably less than 40% by mass, more preferably less than 30% by mass, and most preferably less than 20% by mass relative to mass of a thermoplastic resin forming the toner receptor layer.

The fillers may be organic or inorganic, and substituted with known materials known as stiffeners for binder resins, filling materials, reinforcing materials, etc. Also, the filler may be selected consulting “Handbook: Rubber Plastics Composing Chemicals” (Rubber Digest Ltd.), “New Edition: Plastic Composing Chemicals—Fundamentals And Applications” (Taiseisha), or “Filler Handbook” (Taiseisha).

Examples of the inorganic fillers include inorganic fillers and inorganic pigments such as silica, alumina, a titanium dioxide, a zinc oxide, a zirconium oxide, an iron oxide like mica, zinc white, a lead oxide, a cobalt oxide, strontium chromate, molybdenum pigments, smectite, a magnesium oxide, a calcium oxide, a calcium carbonate, mullite, etc. Among them, Silica or alumina is particularly preferred among them. These fillers may be used individually or in combination of two or more. The filler is preferred to take small sizes of particles. If the size of filler particles is larger, the toner receptor layer is apt to have a coarse surface.

The silica may be spherical or amorphous and may be synthesized by a dry method, a wet method or an aerogel method. Surfaces of hydrophobic silica particles may be treated with a trimethylsilyl group or silicon. In this case, the silica particles are preferably colloidal and, further, porous. Examples of the alumina include anhydrous alumina of a crystal form of α, β, γ, δ, ζ, η, θ, κ, ρ or χ; alumina monohydrate such as pseudoboemite, boemite and diaspore; and trihydrate alumina such as gibbsite and bayerite. The alumina hydrate is more preferable than the anhydrous alumina The alumina is preferred to be porous. The alumina hydrate can be synthesized by a sol-gel method in which alumina is precipitated in a solution of an alminium salt or a method in which an alkali aluminate is hydrolyzed. The anhydrous alumina can be derived by heating alumina hydrate for dehydration.

The filler content of is preferably in a range of from 5 to 2000 parts by mass with respect to 100 parts by dry mass of a binder of the toner receptor layer.

The crosslinking agent is blended for the purpose of adjustment of storage stability and thermoplasticity of the toner receptor layer. Compounds used for the crosslinking agent are those having more than two reactive groups, such as an epoxy group, an isocyanate group, an aldehydo group, an active halogen group, an active methylene group, an acetylene group, and other reactive groups conventionally well known, in one molecule. In addition, the crosslinking agent is substituted with compounds having more than two groups capable of forming an ionic bond, a hydrogen bonding, a coordinate bonding, etc. or conventionally available compounds such as coupling agents for resins, hardening agents, polymerization initiators, polymerization promoters, coagulating agents, film forming agents, film forming auxiliary agents, ect. for resins. Examples of the coupling agents include those of a chlorosilane type, a vinylsilane type, an epoxysilane type, an aminosilanetype, an alkoxy aluminum chelate type or a titanate type and, in addition, those disclosed in “Handbook: Rubber•Plastics Composing Chemicals” (Rubber Digest Ltd.).

It is preferred for the toner receptor layer to contain an antistatic or electrostatic charge control agent for the purpose of controlling toner transfer and toner adhesion and preventing the toner receptor layer from adhesion due to electrostatic charges.

Examples of the antistatic agents are not bounded by type and may selected according to purposes. Examples of the antistatic agents include, but not limited to, cationic surface-active agents such as quaternary ammonium salts, polyamine derivatives, cation-modified polymethyl methacrylate, cation-modified polystyrene, etc.; ampholytic surface-active agents; anionic surface-active agents such as alkylphosphate, anion polymers, etc.; nonionic surface-active agents such as fatty acid ester, polyethylene oxides, etc.; and polyelectrolyte; and electrconductive metal oxides. In the case where a toner has negative electricity, the electrostatic charge control agent is preferred to be cationic or nonionic. Examples of the electroconductive metal oxides include, but not limited to, ZnO, TiO₂, SnO₂, Al₂O₃, In₂O₃, SiO₂, MgO, BaO, MoO₃, etc. These electroconductive metal oxides may be used individually or in any combination of two or more. Further, the electroconductive metal oxide may contain a hetero elements a dopant, for example Al or In for ZnO, Nb or Ta for TiO₂, Sb, Nb or halogens for SnO₂.

It is allowed to add various additives into materials for the toner receptor layer for the purpose of improvement of stability of recorded images and stability of the toner receptor layer itself. Examples of the additives include an antioxidant, an anti-aging agent, an anti-degradation agent, anti-ozonant, an ultraviolet absorption agent, a metal complex, a light stabilizer, an antiseptic agent, a fungicide which are known in the art.

Examples of the antioxidant include, but not limited to, chroman compounds, cumarin compounds, phenolic compounds (e.g. hindered phenol), hydroquinone derivatives, hindered amine derivatives, spiroindan compounds, and those described in, for example, Japanese Unexamined Patent Publication No. 61-159644. Examples of the anti-aging agents include, but not limited to, those described in “Handbook: Rubber•Plastics Composing Chemicals 2^{nd} Revised Edition,” pages from 76 to 121 (1993, Rubber Digest Ltd.). Examples of the ultraviolet absorption agents include, but not limited to, benzotriazole compounds such as described in U.S. Pat. No. 3,533,794,4-thiazolidine compounds such as described in U.S. Pat. No. 3,352,681, benzophenone compounds such as described in Japanese Unexamined Patent Publication No. 46-2784, and ultraviolet absorptive polymers such as described in Japanese Unexamined Patent Publication No. 62-260152. Examples of the metal complexes include, but not limited to, those described in, for example, U.S. Pat. Nos. 4,241,155, 4,245,018 and 4,254,195, and Unexamined Japanese Patent Publication Nos. 61-88256, 62-174741, 63-199248, 1-75568 and 1-74272. In addition, ultraviolet absorptive agents and light stabilizers described in “Handbook: Rubber•Plastics Composing Chemicals 2^{nd} Revised Edition,” pages from 122 to 137 (1993, Rubber Digest Ltd.) can be used.

As was previously mentioned, additives known in the conventional photographic art can be used for the toner receptor layer. Examples of the additives include those described in Research Disclosure Magazine (which is abbreviated to RD) Nos. 17643 (December 1987), 18716 (November 1979) and 307105 (November 1989). These additives appear on the following pages shown in the following Table I.

TABLE I

| Additive | RD No. 17643 | RD No. 18716 | RD No. 307105 |
|---|---|---|---|
| Brightener | 24 | 648R | 868 |
| Stabilizer | 24-25 | 649R | 868-870 |
| Light Absorbent | 25-26 | 649R | 873 |
| (UV Absorbent) | | | |
| Color Image | 25 | 650R | 872 |
| Stabilizer | | | |
| Film Hardener | 26 | 651L | 874-875 |
| Binder | 26 | 651L | 873-874 |
| Plasticizer/Lubricant | 27 | 650R | 876 |
| Coating Auxiliary | 26-27 | 650R | 875-876 |
| (Surface-active | | | |
| agent) | | | |
| Antistatic Agent | 27 | 650R | 976-977 |
| Matting Agent | — | — | 878-879 |

The toner receptor layer is formed by applying a coating liquid containing a polymer over the support with a wire coater and drying it. It is preferred form the polymer coating layer at a melt flow temperature (MFT) higher than a room temperature for storage before printing and lower than 100° C. for toner particle fixation. Further, the spread of the toner receptor layer is preferably in a range of from 1 to 20 g/m² and more preferably in a range of from 4 to 15 g/m² by dried weight. The toner receptor layer is not bounded by thickness and, however, preferably greater than half of a grain size of a toner used for the toner receptor layer, and more preferably one to three times as large as the grain size of toner particle, and, more specifically, preferred to have a thickness in a range of from 1 to 50 μm, more preferably in a range of from 1 to 30 μm, most preferably in a range of from 2 to 20 μm, and ultimately an a range of from 5 to 15 μm.

The following description will be directed to solid state properties of the toner receptor layer.

It is preferred for the toner receptor layer to have a 180° exfoliation strength at a fixing temperature of a fixing member or device less than 0.1 N/25 mm, more preferably 0.041 N/25 mm. The 180° exfoliation strength can be measured using a surface material by the method meeting JIS K6887.

It is preferred for the toner receptor layer to have a high degree of whiteness, specifically, higher than 85% when estimated by the method meeting JIS P8123 and a spectral reflectivity higher than 85% in a wavelength band of from 440 to 640 nm, and more preferably in a wavelength band of from 400 to 700 nm. A difference between the highest and the lowest spectral reflectivity is preferred to be less than 5% in these wavelength ranges.

More specifically, when specifying the degree of whiteness expressed in the CIE 1976 (L*a*b*) color space, it is preferred that the toner receptor layer has an L* value greater than 80, more preferably greater than 85, and most preferably greater than 90. The white tint is preferably as neutral as possible and, in other words, is of a ((a*)²+(b*)²) value expressed in CIE 1976 (L*a*b*) color space less than 50, more preferably less than 18, and most preferably less than 5.

It is preferred for the toner receptor layer to have a high degree of glossiness after image formation, and, specifically, a degree of 45° glossiness greater than 60, more preferably greater than 75, and most preferably greater than 90, in a range of from a white state (which refers to a state where no toner is applied to the toner receptor layer) to a black state (which refers a state where toner is applied to the toner receptor layer at the highest density). However, the degree of 45° glossiness is preferably less than 110 in the same range. If the degree of 45° glossiness is beyond 110, images formed on the toner receptor layer are apt to have metallic gloss which is undesirable in image quality. The degree of glossiness can be estimated by the method meeting JIS Z8741.

It is preferred for the toner receptor layer to have a high degree of surface smoothness, specifically, an arithmetic mean roughness (Ra) less than 3 μm, more preferably less than 1 μm, and most preferably less than 0.5 μm, ranging over the whole density extent (from the white state to the black state). The arithmetic mean roughness (Ra) can be estimated by the method meeting JIS B0601, B0651 and B0652.

It is further preferred for the toner receptor layer to satisfy at least one, more preferably two or more, and most preferably all, of the following solid state properties (1) to (6):

(1) Melt temperature (Tm): preferably higher than 30° C., but within +20° C. from a melt temperature of the toner

(2) Temperature at which the toner layer attains viscosity of 1×10⁵ CP: preferably higher than 40° C. but lower than that of the toner

(3) Storage elastic modulus (G′) and loss elastic modulus (G″) at a fixing temperature: preferably in a range of from 1×10² to 1×10⁵ Pa and in a range of from 1×10² to 1×10⁵ Pa, respectively

(4) Loss tangent (G″/G′) (a ration of loss elastic modulus (G″) to storage elastic modulus (G′)) at the fixing temperature: preferably in a range of from 0.01 to 10

(5) Storage elastic modulus (G′) at a fixing temperature: preferably in a range of from −50 Pa to +2500 Pa of a storage elastic modulus (G′t) of the toner at fixing temperature

(6) Inclination angle of a molten toner on the toner receptor layer: preferably less than 50°, and more preferably less than 40°.

It is preferred for the toner receptor layer to satisfy the solid state properties ddescribed in U.S. Pat. No. 2,788,358, Japanese Unexamined Patent publication Nos. 7-248637, 8-305067 or 10-239889 as well.

It is preferred for the toner receptor layer to have a surface electrical resistivity in a range of from 1×10⁶ to 1×10¹⁵ Ω/cm² under conditions of a temperature of 25° C. and a relative humidity of 65%. If the lower limit surface electrical resistivity of 1×10⁶ Ω/cm² is exceeded, the toner is transferred to the toner receptor layer too small in amount to form an image having a satisfactory density. On the other hand, if the upper limit electrical resistivity of 1×10¹⁵ Ω/cm² is exceeded, there is generated too much electrical charges which cause toner particles to be transfer in sufficiently. This results in that a toner image is poor in density and electrophotographic paper is apt to gather dust by static electricity during handling it. In addition, the elctrophotographic paper possibly encounter miss-feed, double feed of two or more, an occurrence of charge prints and an occurrence of dropouts. The surface electrical resistivity is measured on a sample with a one minute application of 100V in an environment at a temperature of 20° C. and a humidity of 65% after 8-hours humidity regulation of the sample in the same environment by the method meeting JIS K 6911 using a measuring instrument, such as Model R8340 (Advantest Co., Ltd.).

As was previously mentioned, the electrophotographic paper may be provided with certain layers such as a surface protective layer, a backing layer, an interlayer adhesion improvement layer, an under layer, a cushioning layer, an electrostatic charge control or antistatic layer, a reflection layer, a color adjusting layer, a storage stability improvement layer, an anti-adhesion layer, an anti-curling layer and a smoothing layer. These layers may be provided individually or in any combination of two or more.

The surface protective layer is formed over a surface of the toner receptor later for the purpose of surface protection, improvement of storage stability, improvement of handling adaptability, creation of writability, improvement of transport quality through electrophotographic equipments, creation of anti-offset property.

The surface protective layer may be single-layered or multi-layered. It is preferred that the outermost layer of the electrophotoelectric paper (the surface protective payer when it is formed) is well compatible with a toner in terms of fixing performance. Specifically, the outermost layer is preferably such that the contact angle of a molten toner is in a range of from 0 to 40°. Although various types of thermoplastic resins or thermosetting resins can be used for a binder of the surface protective layer, it is preferred to use the same resin as used for the toner receptor layer. However, the surface protective layer is not required to be the same in thermo dynamic and electrostatic characteristics as the toner receptor layer and can be optimized. The surface protective layer may be blended with additives that are usable for the toner receptor layer such as in particular the matting agent as well as the release agent used for the toner receptor layer. Various matting agents conventionally known can be used.

The backing layer is formed on a reverse side surface of the paper support (a surface opposite to an obverse side surface on which the toner receptor layer is formed) for the purpose of creation of back side printing adaptability, and improvement of back side printing quality, curling balance and transport quality through electrophotographic equipments. Though the backing layer is not always bounded by color, it is preferred for the backing layer to be white in the case where the photoelectric paper is two-sided. It is preferred that the backing layer has a degree of whiteness and a spectral reflectivity both higher than 85% similarly to the toner receptor layer. In order to improve double-side printing adaptability of the electrophotoelectric paper, the backing layers for the both side surfaces may be identical in structure with each other. Further, the backing layer may be blended with additives, specifically, the matting agent and the electrostatic charge control or antistatic agent previously described. In the case of using release oil for the fixing rollers, it is preferred for the backing layer to be of an oil absorbing type. The backing layer is preferably between 0.5 and 10 μm in thickness and may be single-layered or multi-layered.

It is preferred to form the interlayer adhesion improvement layer for the purpose of improvement adhesion between the toner receptor layer and the paper support. The interlayer adhesion improvement layer may be blended with various additives, in particular a crosslinking agent, previously described. Further, it is preferred that the electrophotogreaphic paper has a cushioning layer between the interlayer adhesion improvement layer and the toner receptor layer.

The intermediate layer may be formed between the paper support and the interlayer adhesion improvement layer, between the interlayer adhesion improvement layer and the cushioning layer, between the cushioning layer and the toner receptor layer, or between the toner receptor layer and the storage stability improvement layer. In the case where the electrophotogreaphic paper consists of the paper support, the toner receptor layer and the intermediate layer, it is of course to put the intermediate layer between the paper support and the toner receptor layer.

The electrophotogreaphic paper is not bound by thickness and, however, preferably in a rage of from 50 to 550 μm, and more preferably in a range of from 100 to 350 μm, according to its applications.

In electrophotographic printing or copying, images are formed by causing the toner receptor layer to receive a toner or toners. The toner comprises at least a binding resin and a coloring agent and, if necessary, a release agent and other components.

Examples of the binding resin include, but not limited to, a styrene type such as styrene, parachlorosthylene, etc.; a vinyl ester type such as vinyl naphthalene, vinyl chloride, vinyl bromide, vinyl fluoride, vinyl acetate, vinyl propionate, vinyl benzoate, vinyl butyrate, etc.; a methylene aliphatic carboxylate ester type such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate, butyl methacrylate, etc,; a vinyl nitrile type such as acrylonitrile, methacrylonitrile, acrylamide, etc.; s vinyl ether type such as vinyl methyl ether, vinyl ethyl ether, vinyl isobutyl ether, etc.; N-vinyl compounds such as N-vinyl pyrrole, N-vinyl carbazole, N-vinyl indole, N-vinyl pyrrolidone, etc.; homopolymers or copolymers of vinyl monomers of vinyl carboxylate such as methacrylic acids, acrylic acids, cinnamic acids, etc.; and various types of polyester. These binding resin may be used in combination with various types of wax. Among them, it is preferred to use the same type of resin as used for the toner receptor layer.

The coloring agent is not bounded by type and may be of the same type as ordinarily used for toners. Examples of the coloring agent include, but not limited to, pigments such as carbon black, chrome yellow, Hansa yellow, benzidine yellow, slen yellow, quinoline yellow, permanent orange GTR, pyrazolone orange, Vulcan orange, Watchung red, permanent red, brilliant carmine 3B, brilliant carmine 6B, Deipon oil red, pyrazalone red, redole red, rhodamine B lake, lake red C, rose Bengal, aniline blue, ultramarine blue, Carco oil blue, methylene blue chloride, phthalocyanine blue, phthalocyanine green, malachite green oxalate, etc.; and dyes such as acridine dyes, xanthene dyes, azoic dyes, benzoquinone dyes, axine dyes, anthraquinone dyes, thioindigo dyes, dioxazine dyes, thiazine dyes, azomethine dyes, indigo dyes, thioindigo dyes, phthalocyanine dyes, aniline black dyes, polymethine dyes, triphenylmethane dyes, diphenylmethane dyes, thiazine dyes, thiazole dyes, xanthene dyes, etc. These pigments or dyes may be used individually or in any combination of two or more. The coloring agent content is preferably in, but not limited to, a range of from 2 to 8% by mass. The electrophotographic paper possibly encounters aggravation of tintorial power if the coloring agent content is less than 2% by mass, or aggravation of transparency if it exceeds 8% by mass.

The release agent is not bounded by type and may be of the same type as ordinarily used for toners. Examples of the release agent include, but not limited to, comparatively low molecular weight and highly crystalline polyethylene wax, Fischer-Tropsch wax, amide wax, polar wax containing nitrogen such as a compound having a urethane bond. The polyethylene wax is preferably of a molecular weight less than 1000, and more preferably in a range of from 300 to 1000.

The compound having a urethane bond is favorable from the viewpoint that it keeps itself in a solid state due to coagulation power of a polar group even though it has only a small molecular weight and can be set to a higher melt temperature with respect to its molecular weight. The molecular weight of the compound is preferably in a range of from 300 to 1000. Examples of raw materials for the compound include various combinations of substances such as a combination of a diisocyanate type compound and monoalcohol, a combination of a monoisocyanic acid and monoalcohol, a combination of dialcohol and a monoisocyanic aciod, a combination of trialcohol and a monoisocyanic acid, a combination of triisocyanate and a monoisocyanic acid, a combination of triisocyanic compound and monoalcohol, etc. In order to keep the compound from having a higher molecular weight, it is preferred to combine compounds having a multifunctional group and a monofunctional group, respectively, and is important to combine them so as to have quantitatively equivalent functional groups.

Example of the monoisocyanicate compound include, but not limited to, dodecyl isocyanate, phenyl isocyanate, derivatives of phenyl isocyanate, naphthyl isocyanate, hexyl isocyanate, benzyl isocyanate, butyl isocyanate, aryl isocyanate, etc. Example of the diisocyanate compound include, but not limited to, tolylene diisocyanate, 4,4′ diphenyl methane diisocyanate, toluene diisocyanate, 1,3-phenylene diisocyanate, hexamethylene diisocyanate, 4-methyl-m-phenylene diisocyanate, isophorone diisocyanate, etc. Example of the monoalcohol include, but not limited to, methanol, ethanol, propanol, butanol, pentanol, hexanol, heptanol, etc. Example of the dialcohol include, but not limited to, various glycol such as ethylene glycol, diethylene glycol, triethylene glycol, trimethylene glycol, etc. Example of trialcohol include, but not limited to, trimethylol propane, triethylol propane, trimethanol ethane, etc.

The urethane compounds may be used in the form of mixed pulverized type toner by being blended together with a resin and a coloring agent like ordinary release agents.

When using the urethane compounds for an emulsion polymerization-coagulation melt type of toner, a dispersion liquid of particles of the release agent is prepared by dispersing the compound in water together with a polyelectrolyte such as an ionic surface-active agent, a polymer acid or a polymer base; heating to a temperature higher than its melt temperature, and shearing the compound to particulates of a grain size less than 1 μm. The dispersion liquid of the release agent can be used together with a dispersion liquid of resin particles and/or a dispersion liquid of coloring agent.

The toner may be blended with other components such as an internal additive, an electrostatic charge control or antistatic agent, inorganic particulates, etc.

Examples of the internal additive include, but not limited to, magnetic materials such as metals, for example, ferrite, magnetite, reduced iron, cobalt, nickel, manganese, etc., alloys of them; and compounds containing these metals.

Examples of the electrostatic charge control agent include, but not limited to, dye such as quaternary ammonium salt compounds, nigrosin compounds, aluminum, a complex of iron or chrome; and a triphenylmethane type of pigment, etc. which are ordinarily used as an electrostatic charge control agent. In terms of controlling ionic strength which affects stability of the toner during coagulation and melt and reducing wastewater pollution, it is preferred to use an electrostatic charge control agent hardly soluble in water.

Examples of the inorganic particulate include, but not limited to, external additives ordinarily used for surfaces of toner particles such as silica, alumina, titania, calcium carbonate, magnesium carbonate, tricalcium phosphate, etc. It is preferred to use the inorganic particles in the form of a dispersion with an ionic surface-active agent, polymer acid and/or a polymer base.

Surface-active agents can be used for the purpose of emulsion polymerization, seed polymerization, dispersal of pigment, dispersal of resin particles, dispersal of release agent, coagulation, and stabilization of them. It is effective to use an anionic surface-active agent of a sulfurric ester salt type, a sulfonic ester salt type, a phosphate salt type, or a soap type; a cationic surface-active agents of an amine salt type or a quaternary ammonium salt type; and nonionic surface-active agents of a polyethylene glycol type, a type of alkylphenol ethylene oxide adduct or a polyhydric alcohol type; etc. Generally available mills such as a rotary shear type of homogenizer, a ball mill, a sand mill or the like may be used For dispersion of these additives.

The toner may be further blended with an external additive as appropriate. Examples of the external additive include, but not limited to, inorganic particles such as SiO₂ particles, TiO₂ particles, Al₂O₃ particles, CuO particles, ZnO particles, SnO₂ particles, Fe₂O₃ particles, MgO particles, BaO particles, CaO particles, K₂O particles, NaO₂ particles, ZrO₂ particles, CaO.SiO₂ particles, K₂O.(TiO₂)ₙ particles, Al₂O₃.2SiO₂ particles, CaCO₃ particles, MgCO₃ particles, BaSO₄ particles and MgSO₄ particles; and organic particles such as powder of fatty acids, derivatives of the fatty acids or metal salts of them, and powder of fluorocarbon resins, polyethylene resins or acryl resins. It is preferred that these particles have average grain sizes in a range of from 0.01 to 5 μm, and more preferably in a range of from 0.1 to 2 μm.

The toner is not bounded by production method. However, it is preferred to employ a method comprising the following processes (i) to (iii):

(i) a process of preparing a dispersion liquid of coagulated resin particles in a dispersing liquid

(ii) a process of mixing a dispersion liquid of particulates into the dispersion of coagulated resin particles to form particulate-adhered coagulated resin particles

(iii) a process of thermally fusing the particulate-adhered coagulated resin particles to form toner particles

It is preferred for the toner particles to have a volume-average grain size in a range of from 0.5 to 10 μm. The toner possibly causes adverse repercussions in handling adaptability (supply adaptability to supply, swab-rinse adaptability, flowability) and possibly decreases its productivity if the volume-average grain size is too small or possibly causes adverse repercussions in graininess and image transferability which affect image quality and image resolution if it is too large. It is further preferred for the toner particles to have a volume-average grain size distribution index (GSDv) less than 1.3 besides satisfaction of the above requirement for volume-average grain size and, further, a ratio (GSDv)/GSDn) between a volume-average grain size distribution index (GSDv) and a number-average grain size distribution index (GSDn) equal to or greater than 0.9. In addition, it is preferred for the toner to have an average of profile factors expressed by the following equation in a range of from 1.00 to 1.50 besides satisfaction of the above requirement for volume-average grain size.
Profile factor=(π×L²)/(4×S)
where L is the greatest grain size of toner particle and S is the projected area of toner particle.

When satisfying the requirements as set forth above, the toner has notable effects on image quality, more particularly graininess and resolution of an image, prevents an occurrence of drop-outs accompanying toner image transfer and/or an occurrence of blurred toner image, and is apt to have no adverse effect on its handling adaptability even though the average grain size is too small.

It is favorably that that the toner itself has a storage elastic modulus (G′) in a range of from 1×10² to 1×10⁵ Pa in when measured with an angular frequency of 10 rad/sec at a temperature of 150° C. in terms of improvement of image quality and prevention of an occurrence of offsets in the fixing process.

The thermal recording paper comprises, for example, at least a thermal recording layer formed as an image recording layer on the paper support of the present invention and is used in a thermo-autochrome method (AT method) which forms an image by repeating application of heat with a heat-sensitive head and fixation with ultraviolet radiation.

The sublimation transfer paper comprises, for example, at least an ink layer containing thermal diffusion dye (sublimatic dye) formed as an image recording layer on the paper support of the present invention and is used in a sublimation transfer method which transfers the thermal diffusion dye from the ink layer to a sublimation transfer paper by application of heat with a heat-sensitive head.

The thermal transfer paper comprises, for example, at least a hot-melt ink layer formed as an image recording layer on the paper support of the present invention and is used in a melt transfer method which forms an image is formed by heating and transferring the hot-melt ink from the hot-melt ink layer to a thermal transfer paper with a heat-sensitive head. The thermal development paper comprises, for example, the paper support of the present invention and a photosensitive thermal recording layer such as described in, for example, Unexamined Japanese Patent Publication No. 2002-40643 or No. 2004-246026 formed as an image recording layer on the paper support. The thermal development paper after exposure is heated for development of a visible image by a heating roller, a heating belt a plate heater, a thermal head, a laser or a combination of two or more of them.

The silver halide photographic paper comprises, for example, an image recording layer coloring yellow (Y), magenta (M) and cyan (C) formed on the paper support of the present invention and is suitably used in a silver halide photographic method which performs color development, bleaching and fixing, washing, and drying by passing an exposed silver halide photographic paper through processing baths.

The ink-jet paper comprises, for example, a color material receptor layer capable of receiving color materials such as liquid inks, namely an aqueous ink (comprising dye or pigment as a color material) and an oil-based ink, or solid inks that are solid at a normal temperature and is melted and liquidized upon recording, formed as an image recording layer on the paper support of the present invention.

The image recording medium is suitably used as printing paper for offset printing, gravure printing or electrophotographic printing. In this case, it is preferred for the printing paper to have high mechanical strength in terms of application of ink with a printing machine.

The image recording medium of the present invention is capable of forming high quality images because it comprises the support which is not feared to cause blisters, development irregularities and/or fixation irregularities and the image recording layer formed on the support as described above and, therefore, suitably used as electrophotographic paper, thermal.

The image forming method of the present invention comprises the steps of forming a toner image on the electrophotographic medium, for example in the form of paper, of the present invention, smoothing a surface of the toner image and, if necessary, fixing the toner image by heat and other processes.

The toner image forming is not bounded by process and may be of any process capable of forming images on the electrophotographic paper such as a process used in an ordinary electrophotographic method, a process used in a direct transfer method in which a toner image formed on a development roller is directly transferred onto the electrophotographic paper, or a process using an intermediate transfer belt in which a toner image formed on a development roller is primarily transferred onto an intermediate belt and then onto the electrophotographic paper. Among these processes, it is preferred to employ the process using an intermediate transfer belt in terms of environmental stability and qualitative development of images.

The thermal fixation process, which may be carried out between the toner image forming process and a subsequent image surface smoothing process as appropriated, is performed heating the toner image formed in the toner image forming process for fixation using a fixing roller, a fixing belt or a combination of them. The thermal fixation is not bounded by temperature and, however, preferably performed in a range of from 80 to 200° C.

The image surface smoothing process for smoothing a surface of an toner image formed in the toner image forming process is performed by heating, pressing, cooling and peeling off a toner image using a smoothing device having a hot-pressing member, a belt and a cooling, and a peeling device and other device as appropriate. The hot-pressing member is not bounded by type and, however, preferably comprises a pair of heating rollers, or a combination of heating roller and a pressing roller. The cooling device is not bounded by type and, however, of a type of blowing cold air and capable of adjusting an air temperature such as a heatsink. The peeling device is not bounded by type and installation location and, however, preferably installed in a position near a tension roller where the electrophotographic paper peels away from a belt with its own stiffness.

It is preferred to press the electrophotographic paper when bringing the toner image into contact with the heat-pressing member. The pressing is not bounded by process and, however, preferred to be performed using a nip roller. Further, the pressing is not bounded by nip pressure and, however, performed in a range of from 1 to 100 kgf/cm² (from 9.8 to 980 N/cm²), and more preferably a range of from 5 to 30 kgf/cm² (from 49 to 294 N/cm²). It is preferred to perform the heating at a temperature, that depends upon a polymer contained in the toner receptor layer and should be lower a melt point of the polymer, in a range of from 80 to 200° C. It is preferred to perform the cooling at a temperature lower than 80° C. for satisfactory solidification of the polymer, and more preferably in a range of from 20 to 80° C.

The belt comprises a heat resistant support film and a releasing layer formed on the support film. The support film is not bounded by type as long as it is heat resistive. Examples of materials for the heat resistant support film include, but not limited to, polyimide (PI), polyethylene naphthalate (PEN), polyethylene terephthalate, (PET), polyether-therketone (PEEK), polyethersulfone (PES), polyeterimide (PEI), polyparabanic acids (PPA), etc.

The releasing layer preferably contains at least one selected from a group of silicone rubber, fluorine rubber, fluorocarbon siloxane rubber, silicone resins and fluorocarbone resins, etc. More specifically, the belt is preferred to have a fluorocarbon silicone rubber contained layer, a silicone rubber contained layer, or a fluorocarbon silicone rubber contained layer formed over a silicone rubber contained layer.

It is preferred for the fluorocarbon silicone rubber contained layer to use fluorocarbone siloxane rubber having at lease one of a perfluoroalkyl ether group and a perfluoroalkyl group in a principal chain. Preferred example of the fluorocarbons siloxane rubber is a cured matter of a fluorocarbons siloxane rubber composition containing the following components (A) to (D).

(A) a fluorocarbons polymer composed of fluorocarbon siloxane such as expressed by the following general formula (1) as a primary component and having an unsaturated aliphatic group;

(B) at least one of organopolysiloxane and fluorocarbon siloxane that have more than two ≡SiH groups in one molecule and have the contents of ≡SiH group one to four times in molar weight as much as the amount of the unsaturated aliphatic group in the fluorocarbon siloxane rubber composition,

(C) filler,

(D) an effective amount of catalyst.

More specifically, the component (A) is such a fluorocarbon polymer that contains fluorocarbon siloxane having a repeating unit expressed by the following general formula (1) as a principal component and has an unsaturated aliphatic group.

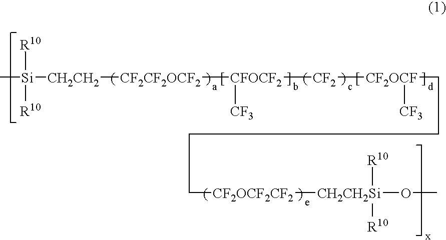

In the formula (1), R¹⁰ is a substitutable or non-substitutable univalent hydrocarbon group having a carbon number of 1 to 8, and preferably an alkyl group having a carbon number of 1 to 8 or an alkenyl group having a carbon number of 2 or 3, and more preferably a methyl group. Suffixes a and e are integers taking a value 0 or 1, respectively; suffixes b and d are integers taking a value between 1 and 4, respectively; and suffix c is an integer between 0 and 8. Suffix x is an integer preferably greater than 1 and more preferably between 10 and 30.

Example of the component (A) include those expressed by the following formula (2).

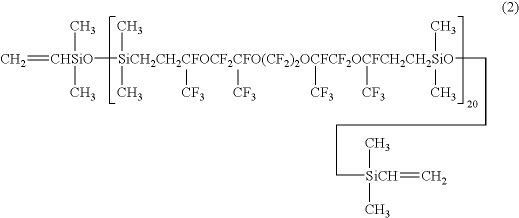

Example of the component (B), namely organopolysiloxane having ≡SiH groups, includes organohydrogen polysiloxane having at least two hydrogen atoms bonded to silicon atoms, respectively, in molecules. In this instance, when the fluorocarbon siloxane rubber composition has the composition (A), i.e. the fluorocarbons polymer, having an unsaturated aliphatic group, it is preferred to use the organohydrogen polysiloxane mentioned above as a curing agent. That is, in this case, a cured matter is formed through an addition reaction between the unsaturated aliphatic group of the fluorocarbon siloxane and the atoms bonded to the silicon atoms of the organohydrogen polysiloxane. For the organohydrogen polysiloxane, such organohydrogen polysiloxane that are used to produce an addition curing type of silicon rubber compositions can be available. It is preferred for the organohydrogen polysiloxane to have ≡SiH group, at least one for one unsaturated aliphatic hydrocarbon group in the component (A) i.e. the fluorocarbon siloxan. Example of the component B, i.e. the fluorocarbon having ≡SiH groups, is the unit expressed by the formula (1) or those having a dialkyl hydrogensiloxy group for R¹⁰ of the formula (1) besides having a dialkyl hydrogensiloxy group or a silyl group for the terminal group, i.e. ≡SiH group, more preferably those expressed by the general formula (3).

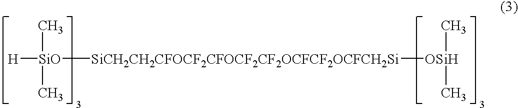

Examples of the component (C), i.e. filler, include various fillers conventionally used in general silicon rubber compositions, specifically stiffening fillers such as aerosol silica, precipitated silica, carbon powder, titanium dioxides, aluminum oxides, quartz powder, talc, sericite and bentonite; and fiber filler such glass fiber and organic fibers.

Examples of the component (D), i.e. catalyst, include catalysts known as addition reaction catalyst such as those carrying a chloroplatinic acid, an alcohol-modified chloroplatinic acid, a complex of chloroplatinic acid and olefin, platinum black or palladium on a substrate such as alumina, silica or carbon; elements of the VIII series of the periodic table or compounds of the elements such as complexes of rhodium and olefin, chlorotris (triphenylphosphine) rhodium (Wilkinson catalyst), and rhodium(III) acetylacetonate. It is preferred to use these complexes dissolved in alcohol, ether or hydrocarbon.

The fluorocarbon siloxane rubber composition may be blended with various compounding agents examples of which include, but not limited to, a dispersing agent such as diphenylsilanediol, a low polymerization grade of dimethylpolysiloxane of a molecular chain ended with a hydroxyl group, or hexamethyldisilazane; a thermal resistance improving agent such as a ferrous oxide, a ferric oxide, a cerium oxide, a ferric octylate; and a coloring agent such as pigment.

The fixing belt is prepared by applying a layer of the fluorocarbon silixane rubber composition to the thermal resistive support film and curing it with heat. If necessary, it is possible to coat a solution of the fluorocarbon silixane rubber composition diluted with a solvent such as m-xylene hexafluoride or benzotrifluoride by a general coating method such as a spray coating method, a dip coating method or a knife coating method. The coating is not bounded by curing temperature and curing time and may be performed at a temperature in a range of from 100 to 500° C. and in a time in a range of from 5 seconds to 5 hours according to types and manufacturing methods of the support film.

The releasing layer of the thermal resistive support film is not bound by thickness and preferably in a range of from 1 to 200 μm, and more preferably in a range of from 5 to 150 μm.

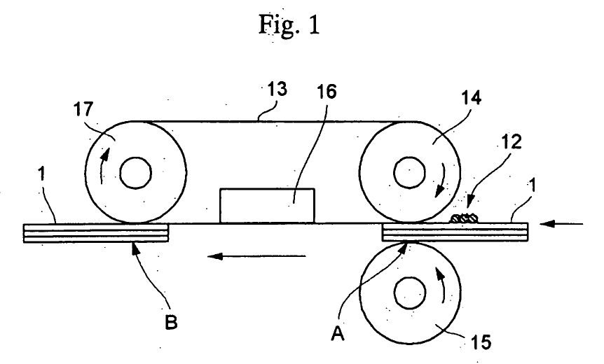

Referring to FIG. 1 showing to an example of a fixing and smoothing device for use with an electrophotographic image forming apparatus, at the beginning, toner particles 12 are transferred onto an electrophotographic paper 1 by an image forming device (not shown). Then, the electrophotographic paper 1 with toner particles transferred thereto is transported to a position A by means of a conveyer device (not shown) and is passed through between a heating roller 14 and a pressure roller 15. These rollers 14 and 15 heat and press the electrophotographic paper 1 at a fixing temperature and a pressure sufficiently high to soften the toner receptor layer of the electrophotographic paper 1 or the toner particles 12. In this instance, the term “fixing temperature” as used herein shall mean and refer to a temperature of a surface of the toner receptor layer measured at the position A where the rollers 14 and 15 nip at the electrophotographic paper 1 and is preferably in a range of from 80° to 190° C., and more preferably in a range of from 100° to 170° C. The term “pressure” as used herein shall mean and refer to a nip pressure applied to the toner receptor layer measured at the position A and is preferably in a range of from 1 to 10 kgf/cm² (from 9.8 to 98 N/cm²) and more preferably in a range of from 2 to 7 kgf/cm² (from 19.6 to 68.6 N/cm²). Subsequently, while the electrophotographic paper 1 after heated and pressed is transported toward a cooling device 16 by a fixing belt 13, the release agent discretely distributed in the toner receptor layer is sufficiently heated to solve out onto the surface of the toner receptor layer. Then, the eluting release agent forms a releasing layer or film on the surface of the toner receptor layer. Thereafter, the electrophotographic paper 1 is further transported to a cooling device 16 and is cooled to a temperature lower than a softening temperature of a binder resin for a polymer of the toner receptor layer or a binder resin of the toner or lower than +10° C. from a glass-transition temperature of the binder resin, and, more specifically, to a temperature preferably in a range of from 20° to 80° C., and more preferably to a room temperature of approximately 25° C. As a result, the release agent on the toner receptor layer is cooled down and solidified to form a releasing layer. The cooled electrophotographic paper 1 is further transported to a position B by the fixing belt 13 moving around a tension roller 17 and, then, peeled away from the fixing belt 13 in the position B. It is preferred that the tension roller is small in diameter sufficiently enough to allow the electrophotographic paper peels off with its own rigidity (stiffness).

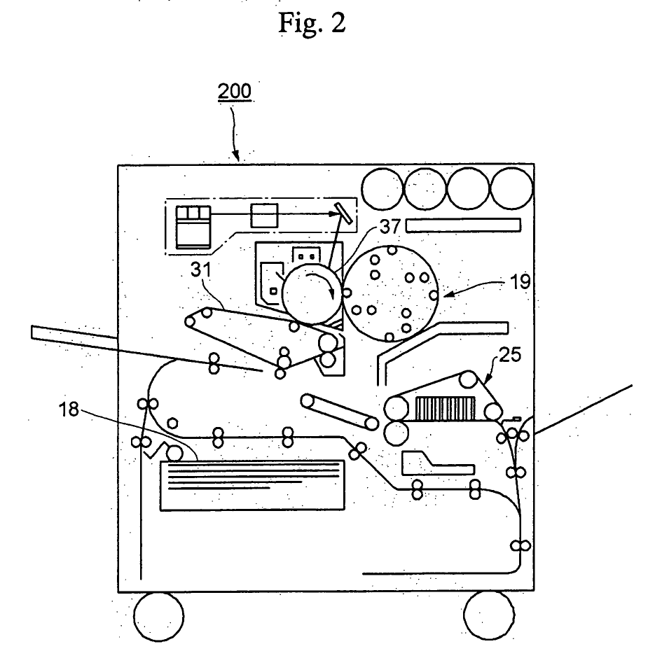

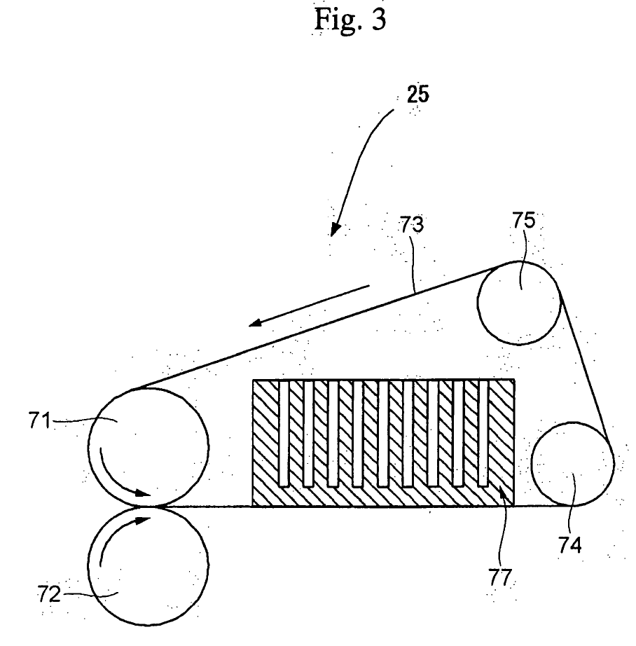

FIG. 2 schematically shows an electrophotographic machine 200 such as, for example, Full Color Laser Printer, Model DCC-500 (Fuji Xerox Co., Ltd.) equipped with a belt-fixing type smoothing device schematically shown in FIG. 3. The electrophotographic machine 200 comprises a photosensitive dram 37, a processor 19, an intermediate transfer belt 31, and a belt-fixing device (smoothing device) 25.

FIG. 3 shows the belt-fixing device 25 operative to fix and smooth an image. The belt-fixing device 25 comprises a heating roller 71, a peeling roller 74, a tension roller 75, an endless belt 73 mounted around these rollers 71, 74 and 75, a pressure roller 72 forced against the heating roller 71 through the endless belt 73, and a heatsink 77 disposed between the heating roller 71 and the peeling roller 74. The electrophotographic paper is transported by the endless belt 73 and forcibly cooled by the heat sink 77. More specifically, the electrophotographic paper 1 with a color toner image transferred and fixed thereto is introduced into a nip between the heating roller 71 and the pressure roller 72 by the endless belt 73. During passing through between the heating roller 71 and the pressure roller 72, the color toner image is fused at a temperature in a range of, for example, from 120 to 130° C. and fixed to the toner receptor layer of the electrophotographic paper. Thereafter, the electrophotographic paper is further transported with the toner receptor layer remaining in contact with the endless belt 73. During the transportation, the endless belt 73 is forcibly cooled by the heatsink 77, thereby cooling and solidifying the color toner image together with the toner receptor layer. Finally, the electrophotographic paper peels off with its own rigidity (stiffness) by the aid of the peeling roller 74.

After completion of the peeling process, the endless belt 73 is cleaned for removal of toner particles remaining thereon by a cleaner (not shown) and prepared for fixation of another electrophotographic paper.

The image recording method of the present invention described above has a distinguished adhesion property between the paper support and the toner receptor layer and a distinguished antistatic property, excels in transport quality during manufacturing and using the electrophotographic paper, is capable of forming high quality images without an occurrence of blisters, image recording irregularities and/or image fixing irregularities.

The following description will be directed to examples of the support for an image recording medium of the present invention.

### EXAMPLE 1

The paper support for image recording paper of example 1 (Ex 1) was prepared in the following manner. Paper pulp having an average fiber length of 0.63 mm was prepared by beating bleached broadleaf tree kraft pulp (LBKP) to a freeness of 340 ml (Canadian Standard Freeness: C.S.F.) using a conical refiner, and then three parts by mass of sodium carboxymethyl cellulose (the degree of etherification: 0.25; average grain size: 20 μm) of a water swelling type was added and dispersed in 100 parts by mass of the pulp. Subsequently, cation starch, akylketenedimer (AKD), anion polyacrylamide and polyamide polyamine epichlorohydrin were added into the pulp at a mass ratio of 1.0:0.5:0.2:0.3 in percent by mass with respect to the pulp. In this instance, an alkyl part of the alkylketenedimer (AKD) is derived from a fatty acid primarily composed of a behenic acid as a primary component. The pulp stock thus prepared was processed to make 150 μm² basic weight of base paper using a fourdrinier machine. During the processing, 1.2 g/m² of carboxy-modified polyvinyl alcohol (PVA) and 0.3 g/m² of CaCl₂ was impregnated in the base paper in an intermediate zone of a drying stage of the fourdrinier machine. At the end stage of the fourdrinier machine, the base paper was soft calendered to adjust paper density to 0.98 g/m³ using a metal roller at a surface temperature of 120° C. for the obverse side surface (a surface on which an image is formed) and a resin roller at a surface temperature of 50° C. for the reverse side surface.

Subsequently, a corona discharge treatment was applied to the obverse side surface of the base paper, and a layer of low density polyethylene (LDPE) blended with 10% by mass of titanium dioxide was coated by melt-extrusion so as to form a polyethylene coating layer 30 μm thick on the obverse side surface of the base paper. Further, a corona discharge treatment was applied to the reverse side surface of the base paper, and polyethylene compositions were coated by multilayer coextrusion so as to form a first or under polyethylene layer 13 μm thick and a second or outer polyethylene layer 13 μm on the reverse side surface of the base paper. The polyethylene composition was composed of two parts by mass of high density polyethylene (HDPE) blended with 5% by mass of polyether type polymeric antistatic agent (commercially available example: Pelestat 300, Sanyo Chemical Industries, Co. Ltd.) and one part of low density polyethylene (LDPE) for the first polyethylene layer, and two parts by mass of high density polyethylene (HDPE) blended with 3% by mass of polyether type polymeric antistatic agent (commercially available example: Pelestat 300, Sanyo Chemical Industries, Co. Ltd.) and one part of low density polyethylene (LDPE) for the second polyethylene layer.

### EXAMPLES 2 TO 7 AND COMPARATIVE EXAMPLES 1-5

The paper support for image recording paper of examples 2 to 7 (Ex 2 to Ex 7) and comparative examples 1 to 5 (Exc 1 to Exc 5) were prepared in the same process as example 1. However, chemical compositions used for the supports of Examples 2-7 and comparative examples 1-5 were the same as those for the support of example 1 (Ex 1) except that the second polymer layer was altered as summarized in Table II. Further, in example 7, a layer of high density polyethylene (HDPE) blended with 3% by mass of polyether type polymeric antistatic agent (commercially available example: Pelestat 300, Sanyo Chemical Industries, Co. Ltd.) in addition to 10% by mass of titanium dioxide was coated by melt-extrusion so as to form a polyethylene coating layer 30 μm thick on the obverse side surface of the base paper. Further, in example 1 and comparative examples 2, 3 and 5, the reverse side polyethylene coating layer was formed 26 μm thick by a first polyethylene layer only which was composed of two parts by mass of high density polyethylene (HDPE) without polymeric antistatic agent and one part of low density polyethylene (LDPE). In comparative examples 4 and 5, the reverse side polyethylene coating layer was formed by coating a single layer of antistatic agent-free polymer only and then spreading or over coating a low molecular weight type antistatic agent shown in Table II.

TABLE II

| | | 1st polymer coating layer | | 2nd polymer coating layer | | |
|---|---|---|---|---|---|---|
| | Metal | | Antistatic | | Antistatic | Antistatic |
| | compound in | Resin type | agent | Resin type | agent | agent for |
| | base paper | (thickness) | (content) | (thickness) | (content) | reverse side |
| Ex 1 | CaCl₂ | HDPE/LDPE = 2:1 | PE | HDPE/LDPE = 2:1 | PE | Non |
| | 0.3 g/m² | 13 μm | 5% by mass | 13 μm | 5% by mass | |
| Ex 2 | CaCl₂ | HDPE/LDPE = 2:1 | | HDPE/LDPE = 2:1 | PE | Non |
| | 0.8 g/m² | 18 μm | | 8 μm | 5% by mass | |
| Ex 3 | CaCl₂ | HDPE/LDPE = 2:1 | | HDPE/LDPE = 2:1 | PE | Non |
| | 0.3 g/m² | 18 μm | | 8 μm | 5% by mass | |
| Ex 4 | CaCl₂ | HDPE/LDPE = 2:1 | | HDPE/LDPE = 2:1 | PE | Non |
| | 0.98 g/m² | 18 μm | | 8 μm | 5% by mass | |
| Ex 5 | CaCl₂ | HDPE/LDPE = 2:1 | | HDPE/LDPE = 2:1 | PE | Non |
| | 0.6 g/m² | 20 μm | | 6 μm | 5% by mass | |
| Ex 6 | CaCl₂ | HDPE/LDPE = 2:1 | PE | HDPE/LDPE = 2:1 | PE | Non |
| | 0.5 g/m² | 20 μm | 3% by mass | 6 μm | 5% by mass | |
| Ex 7*¹ | CaCl₂ | HDPE/LDPE = 2:1 | Non | Non | | Non |
| | 0.5 g/m² | 26 μm | | | | |
| Exc 1 | Non | HDPE/LDPE = 2:1 | Non | Non | | Non |
| | | 26 μm | | | | |
| Exc 2 | CaCl₂ | HDPE/LDPE = 2:1 | PE | Non | | Non |
| | 0.8 g/m² | 26 μm | 3% by mass | | | |
| Exc 3 | CaCl₂ | HDPE/LDPE = 2:1 | PE | Non | | Non |
| | 0.3 g/m² | 26 μm | 10% by mass | | | |
| Exc 4 | NaCl | HDPE/LDPE = 2:1 | Non | HDPE/LDPE = 2:1 | Non | SO |
| | 0.2 g/m² | 26 μm | | 8 μm | | 0.3 g/m² |

| | | | | | |
|---|---|---|---|---|---|
| Exc 5 | NaCl | HDPE/LDPE = 2:1 | Non | Non | ST/SB |
| | 0.6 g/m² | 26 μm | | | 0.1:1 (g/m²) |

*¹Obverse side polymer coating layer is blended with 3% by mass of polyethylene (PE)

In the Table II, SO, ST/SB, AB, PE and IP stand for sorbitan fatty acid ester (lower molecular weight antistatic agent for over coating), suthylene anhydride sodium maleate/stylene butadiene rubber (polymeric antistatic agent for over coating), alkylbenzene sodium sulfonate (low molecular weight antistatic agent for blend), a polyether type anti-static agent (low molecular weight antistatic agent for blend: Pelestat 300, Sanyo Chemical Industries, Co. Ltd.), and a potassium ionomer (low molecular weight antistatic agent for blend), respectively.

The paper base supports of the respective examples Ex 1-7 and comparative examples Exc 1-5 were visually assessed on foreign particle adhesion, surface quality of reverse side polymer coating layers, adhesive quality between the paper support and the obverse side and the reverse side polymer coating layer, according to the following grades, and the results are shown in Table III.

The foreign particle adhesion was assessed in the following grade on view of dust, tiny coarse particles, and other foreign particles on the paper support

Assessment Grade for Foreign Particle Adhesion

5: Absolutely eligible for support (no foreign particles is observed)

4: Eligible for support (foreign particles negligible in number are observed)

3: Acceptable for support (foreign particles are observed)

2: Ineligible for support (a lot of foreign particles are observed)

1: Absolutely eligible for support (a great number of foreign particles are observed)

The surface quality of reverse side polymer coating layer was assessed in the following grade on view of a surface of the reverse side polymer coating layer of the paper support.

Assessment Grade for Surface Quality

5: Absolutely eligible for support (no irregularities in color tone and contour is observed)

4: Eligible for support (slight irregularities in color tone and contour are observed)

3: Acceptable for support (irregularities in color tone and contour are observed)

2: Ineligible for support (a lot of irregularities in color tone and contour are observed)

1: Absolutely ineligible for support (a great number of foreign particles are observed)

The adhesive quality of the support was visually assessed in the following grade on view of adhesive failures between the base paper and the obverse side and the reverse side polymer coating layer. The assessment was performed on two postcard-sized paper supports with their obverse and reverse side polymer coating layers overlapped face to face that were weighed down with a weight of 1 kg and left as they were for a month.

Assessment Grade for Adhesive Quality

5: Absolutely eligible for support (no adhesion between the obverse and reverse polymer coating layers is observed)

4: Eligible for support (very weak adhesion between the obverse and reverse polymer coating layers is locally observed)

3: Acceptable for support (weak adhesion between the obverse and reverse polymer coating layers irregularities in color tone and contour is observed)

2: Ineligible for support (strong adhesion failures between the obverse and reverse polymer coating layers is locally observed)

1: Absolutely ineligible for support (a significantly strong adhesion is locally observed)

TABLE III

| | Support for image recording medium | | |
|---|---|---|---|
| | Foreign particle | | |
| | adhesion | Surface quality | Adhesive failur, |
| Ex 1 | 4 | 5 | 5 |
| Ex 2 | 5 | 5 | 5 |
| Ex 3 | 5 | 5 | 5 |
| Ex 4 | 5 | 5 | 5 |
| Ex 5 | 5 | 5 | 5 |
| Ex 6 | 4 | 5 | 6 |
| Ex 7 | 4 | 5 | 5 |
| Exc 1 | 2 | 5 | 5 |
| Exc 2 | 3 | 5 | 5 |
| Exc 3 | 5 | 3 | 5 |
| Exc 4 | 3 | 5 | 5 |
| Exc 5 | 4 | 5 | 2 |

### EXAMPLES 8 TO 14 AND COMPARATIVE EXAMPLES 6-10

The electrophotographic paper of examples 8 to 14 (Ex 8 to Ex 14) and comparative examples 6 to 10 (Exc 6 to Exc 10) were prepared in the following manner.

A dispersion liquid of titanium dioxide (containing 40% by mass of a pigment of titanium dioxide) was prepared by mixing and agitating a titanium dioxide by mixing 40.0 g of titanium dioxide (Taipek A-220: Ishihara Sangyo Co., Ltd.), 2.0 g of polyvinyl alcohol (PVA102: Kurare Co., Ltd.) and 58.0 g of ion-exchange water together and dispersing it using a dispersion machine (Model NBK-2: Nihon Seiki Co., Ltd.). Thereafter, a coating liquid for the toner receptor layer was prepared by mixing 15.5 g of the titanium dioxide dispersion liquid prepared as above, 15.0 g of dispersion liquid of carnauba wax (Serozole 524: Chukyo Oil & Fats Co., Ltd.), 100.0 g of water dispersion of a polyester resin (KAZ-7049: Unitika Ltd), having a solid content of 30% by mass, 0.2 g of viscosity improver, (Alcox: Meisei Chemical Co., Ltd.), 0.5 g of anion surface active agent (AOT), and 80 ml of ion-exchange water. Viscosity and surface tension of the coating liquid were adjusted to 40 mPa·s and 34 mN/m, respectively.

Separately, a coating liquid for the backing layer was prepared by mixing 100 g of water dispersion of an acrylic resin (Hyros XBH-997L: Seiko Chemical Industry Co., Ltd.) having a solid content of 30% by mass, 5.0 g of matting agent (Tecpolymer MBX-12: Sekisui Chemical Co., Ltd.), 10.0 g of release agent (Hydrin D337: Chukyo Oil & Fats Co., Ltd.), 2.0 g of viscosity improver (CMC), 0.5 g of anion surface active agent (AOT), and 80 ml of ion-exchange water. Viscosity and surface tension of the cast coating liquid was adjusted to 35 mPa·s and 33 mN/m, respectively.

A backing layer was formed on the reverse side surface of each of the paper supports of examples Ex 1-7 and comparative examples 1-4 by applying the coating liquid prepared as above for the backing layer using a bar coater so as to have a dry spread of 9 g/m². Subsequently, a toner receptor layer was formed on the obverse side surface of each of the paper supports of examples Ex 1-7 and comparative examples 1-4 by applying the coating liquid prepared as above for the toner reception layer using a bar coater so as to have a dry spread of 12 g/m². In this instance, the toner receptor layer was adjusted in pigment content to 5% by mass with respect to the thermoplastic resin. Then, the toner receptor layer and the backing layer were dried by an online hot-air blower. The hot-air flow rate and hot-air temperature were adjusted so as to dry out the layers within two minutes after application of the layers. The dry point was set to a surface temperature of the coating layer becoming equal to a wet-bulb temperature of the hot-air. After drying, the paper support was further calendered using a gloss calender machine with a metal roll kept at a surface temperature of 40° C. under a nip pressure of 14.7 kN/m² (15 kgf/cm²) to complete the electrophotographic paper of examples 8-14 and comparative examples 6-10.

A test pattern of images was formed on the electrophotographic paper of the examples 8-14 and comparative examples 6-10 using a full color laser printer, Docu Color Moel DCC-500 (Fuji Xerox Co., Ltd), with the fixing device replaced with the surface smoothing device shown in FIG. 3 for performing surface smoothing under the following conditions.

-Belt-

Belt base: polyimide (P1) film; width: 50 cm; thickness: 80 μm
Releasing layer: a film of fluorocarbon siloxane rubber formed by vulcanization curing SIFEL610 (Shin-Etsu Chemical Co., Ltd.) that is a precursor of fluorocarbon siloxane rubber
   -Heating and Pressing Process-
Heating Roller Temperature: Adjustable
Nip pressure: 130 N/cm²
   -Cooling Process-
Cooling device: heatsink: 80 mm in length
Transport speed: 53 mm/sec

The transport quality of the electrophotographic paper of examples 8-14 and comparative examples 5-10 was assessed in terms of adhesion quality to the toner receptor layer and running property when the electrophotographic paper travels in the full color laser printer, Docu Color Moel DCC-500 for printing. The result is shown in Table IV.

The adhesive quality was visually assessed in the following grade on view of the number of peelings greater than 1 mm (local breakage of the toner receptor layer) when making 100 A4 size prints under the same condition as discussed above.

Assessment grade for adhesive quality

5: Very excellent for electrophotographic print (no peelings is observed)

4: Excellent for electrophotographic print (one or two peelings are observed)

3: Acceptable for electrophotographic print (peelings are observed between three and ten)

2: Ineligible for electrophotographic print (peelings are observed 11 20)

1: Absolutely ineligible for electrophotographic print (more than 21 peelings are observed)

The transport quality was assessed in the following grade in terms of the frequency of transport failure such as paper jamming and double feeds when repeating continuous test printing of 50 prints two times under the same condition as described above using Docu Color Moel DCC-500.

5: Very excellent quality (no transport failure occurs)

4: Excellent quality (transport failure occurs to one print per 100 prints)

3: Acceptable quality (transport failure occurs to two to five prints per 100 prints)

2: Poor quality (transport failure occurs six to ten prints per 100 prints)

1: Very poor quality (transport failure occurs to more than 11 prints per 100 prints)

The image quality was visually accessed according to the following grade.

Absolutely ineligible for support (a significantly strong adhesion is locally observed)

⊚ Very excellent (suitable for high quality image recording medium)

◯ Excellent (suitable for high quality image recording medium)

Δ Moderate (acceptable for quality image recording medium)

X Poor (ineligible for quality image recording medium)

The color fade-out was visually assessed after leaving the prints at a temperature 50° C. and a relative humidity of 80% for five days.

⊚ Very excellent (no color fade-out is observed; suitable for high quality image recording medium)

◯ Excellent (imperceptible color fade-out is observed; suitable for high quality image recording medium)

Δ Moderate (conspicuous color fade-out is observed; unacceptable for quality image recording medium)

X Poor (notable color fade-out is observed; ineligible for quality image recording medium)

TABLE IV

| | Electrophotographic paper | | | |
|---|---|---|---|---|
| | Adhesive | | | |
| | quality | Transport quality | Image quality | Color fade-out |
| Ex 8 | 5 | 4 | ⊚ | ⊚ |
| Ex 9 | 5 | 5 | ⊚ | ⊚ |
| Ex 10 | 5 | 5 | ⊚ | ⊚ |
| Ex 11 | 5 | 5 | ⊚ | ⊚ |
| Ex 12 | 5 | 5 | ⊚ | ⊚ |
| Ex 13 | 5 | 4 | ⊚ | ⊚ |
| Ex 14 | 5 | 4 | ⊚ | ⊚ |
| Exc 6 | 5 | 1 | ◯ | ⊚ |
| Exc 7 | 5 | 2 | ◯ | ⊚ |
| Exc 8 | 3 | 5 | Δ | ◯ |
| Exc 9 | 3 | 2 | ◯ | ◯ |
| Exc 10 | — | — | — | — |

It is prooved from the Table III and Table IV that the image recording mediums of examples 1-7 which have a polymer coating layer blended with a polymeric antistatic agent at opposite sides of the paper support containing a metal compound are excellent in antistatic property and is, consequently, free from dust, tiny coarse particles and other foreign particles, and also excellent in adhesive quality between the base paper and the polymer coating layer. Regarding the electrophotographic paper of examples 8-14 comprising the paper supports of examples 1-7, respectively, the electrophotographic paper is excellent in adhesive quality between the paper support and the toner receptor layer and transport quality in printing machines and provides high quality images without color fadeout besides it is free from transport failure such as paper jamming and double feeds.

It is proved that, on the contrary, the support of comparative example 1 and the image recording medium of comparative example 6 which have a reverse side polymer coating layer without polymeric antistatic agent are inferior in antistatic property and transport quality and cause color fade-out of an image. Further, regarding the electrophotographic paper of comparative example 7 comprising the paper support of comparative example 2 which comprises a reverse side polymer coating layer containing a polymeric antistatic agent and a base paper containing no metal compound, the electrophotographic paper of comparative example 8 comprising the paper support of comparative example 3 which comprises a reverse side polymer coating layer containing a low molecular weight antistatic agent, and the electrophotographic paper of comparative examples 9 and 10 comprising the paper support of comparative examples 4 and 5, respectively, which comprise a reverse side polymer coating layer containing no polymeric antistatic agent but coated with an antistatic agent, they are inferior in antistatic property and transport quality to the remaining paper and case color fade-out of an image.

While the invention has been described in detail in conjunction with specific embodiments thereof, it will be apparent to those skilled in the art that various other embodiments and variants can be made without departing from the spirit and scope of the invention.

What is claimed is:

1. A support for image recording medium which comprise:
base paper containing a metallic compound;
at least one obverse side polymer coating layers formed on an obverse side surface of said base paper on which an image recording layer is formed; and
at least one reverse side polymer coating layers formed on a reverse side surface of said base paper;
wherein at least one of said obverse side polymer coating layers and said reverse side polymer coating layers contains a blending polymeric antistatic agent therein.

2. A support for image recording medium as defined in claim 1, wherein said blending polymeric antistatic agent comprises one selected from a group of a polyether type of polymeric antistatic agent, a betaine type of polymeric antistatic agent and an ionomer type of polymeric antistatic agent.

3. A support for image recording medium as defined in claim 1, wherein a content of said blending polymeric antistatic agent is in a range of from 1 to 30% by mass.

4. A support for image recording medium as defined in claim 1, wherein said metallic compound comprises at least one of alkali metal salts and alkali earth metal alts.

5. A support for image recording medium as defined in claim 1, wherein a content of said metallic compound is greater than 0.3 g/m².

6. A support for image recording medium as defined in claim 1, wherein said base paper has at least two said reverse side polymer coating layers at least one of which contains said blending polymeric antistatic agent.

7. A support for image recording medium as defined in claim 6, wherein said blending polymeric antistatic agent is contained in an outermost layer of said reverse side polymer coating layers.

8. A support for image recording medium as defined in claim 1, wherein said polymer coating layer contains a polyolefin resin.

9. An image recording medium comprising:
a support comprising base paper containing a metallic compound and at least one polymer coating layer formed on an obverse side surface and a reverse side surface of said base paper, at least one of said polymer coating layers containing a polymeric antistatic agent blended therein; and
an image recording layer formed over said polymer coating layer on said obverse side surface of said base paper.

10. A method for manufacturing a support for an image recording medium which comprises base paper containing a metallic compound, at least one polymer coating layer formed on an obverse side surface of said base paper on which an image recording layer is formed, and at least polymer coating layer formed on a reverse side surface of said base paper, at least one of said polymer coating layers containing a blending polymeric antistatic agent therein, said method for manufacturing said support comprising the steps of:
preparing a polymer composition with a polymeric antistatic agent blended therein; and
forming at least one layer of said polymer composition on an obverse side surface of said base paper by melt lamination.

11. A method for forming an image on an electrophtographic recording medium which comprises a support comprising base paper containing a metallic compound and at least one polymer coating layer formed on an obverse side surface and a reverse side surface of said base paper, at least one of said polymer coating layers containing a polymeric antistatic agent blended therein and a toner receptor layer formed over said polymer coating layer on said obverse side surface of said base paper, said image recording method comprising steps of:
transferring a toner image onto said toner receptor layer of said electrophotographic recording medium; and
fixing and smoothing a surface of said toner image on said electrophotographic recording medium.
